(19) United States
(12) Patent Application Publication
(10) Pub. No.: US 2025/0242582 A1
(43) Pub. Date: Jul. 31, 2025

(54) IMAGE FORMING SYSTEM AND HEAD MOVING METHOD

(71) Applicant: BROTHER KOGYO KABUSHIKI KAISHA, Nagoya (JP)

(72) Inventors: Toshiro UEDA, Inazawa (JP); Rintaro ITO, Ogaki (JP)

(73) Assignee: BROTHER KOGYO KABUSHIKI KAISHA, Nagoya (JP)

(21) Appl. No.: 19/003,168

(22) Filed: Dec. 27, 2024

(30) Foreign Application Priority Data
Jan. 31, 2024 (JP) 2024-012908

(51) Int. Cl. B41J 2/045

(52) U.S. Cl. CPC B41J 2/04533; B41J 2/04541

(57) ABSTRACT

There is provided an image forming system including: a head; a head moving mechanism including a stepping motor; and a controller configured to: in a case where the head is moved to a first position, rotate the stepping motor until the head arrives at a first preliminary position and rotate the stepping motor by a step number S₁; in a case where the head is moved to a second position, rotate the stepping motor until the head arrives at a second preliminary position and rotate the stepping motor by a step number S₂; and in a case where the head is moved to a third position, rotate the stepping motor until the head arrives at a third preliminary position and rotate the stepping motor by a step number S₃.

### REFERENCE TO RELATED APPLICATIONS

This application claims priority from Japanese Patent Application No. 2024-012908 filed on Jan. 31, 2024. The entire content of the priority application is incorporated herein by reference.

### BACKGROUND ART

An image forming system which forms an image on a medium (sheet, etc.) by ejecting an ink to the medium from a head having nozzles is used. An image forming system, which is configured to move the head between an image formation position for forming the image on the medium and a position (for example, a maintenance position) separated from the image formation position, is also known as a type of the image forming system as described above.

There is a sheet digital printing machine including a head holding unit and a guide member. The head holding unit includes a nozzle head. The guide member guides the nozzle head of the head holding unit between a first position inside the printing machine and a second position outside the printing machine.

### SUMMARY

There is an image forming system including a plurality of image formation positions. The plurality of image formation positions includes, for example, a main image formation position and a sub image formation position. The main image formation position is the position which is mainly used for the image formation by the image forming system. The sub image formation position is used, specifically for example, in a case where a head is adjusted and in a case where a malfunction is occurred in a part of heads.

However, moving the head suitably to each of the plurality of image formation positions by using the configuration of the sheet digital printing machine described above is not easy.

An object of the present disclosure is to provide an image forming system and a head moving method each of which is capable of moving a head quickly and precisely to each of a plurality of image formation positions.

According to a first aspect of the present disclosure, there is provided an image forming system including:
a head configured to form an image on a medium by ejecting a liquid;
a head moving mechanism configured to move the head along a head movement direction between an image formation area at one end in the head movement direction and an escape area at other end in the head movement direction, the head moving mechanism including:
   a carriage supporting the head;
   a stepping motor;
   a power transmitter which is connected to the carriage and the stepping motor and which is configured to transmit a power of the stepping motor to the carriage; and
   a first sensor and a second sensor each configured to sense that the head is located in the image formation area, and each configured to be in an OFF state in a case where the head is located in the escape area; and
a controller electrically connected to the stepping motor, the first sensor, and the second sensor, the controller being configured to:
in a case where the head is moved from the escape area to a first position in the image formation area, rotate the stepping motor in one direction until the head arrives at a first preliminary position at which the first sensor turns from the OFF state to an ON state, so as to move the head at a first velocity toward the one end, and rotate the stepping motor by a step number S₁ in the one direction from a point in time at which the head has arrived at the first preliminary position, so as to move the head to the first position at a second velocity smaller than the first velocity;
in a case where the head is moved from the escape area to a second position, in the image formation area, different from the first position, rotate the stepping motor in the one direction until the head arrives at a second preliminary position at which the second sensor turns from the OFF state to the ON state, so as to move the head at the first velocity toward the one end, and rotate the stepping motor by a step number S₂ in the one direction from a point in time at which the head has arrived at the second preliminary position, so as to move the head to the second position at the second velocity; and
in a case where the head is moved from the escape area to a third position, in the image formation area, different from the first position and the second position, rotate the stepping motor in the one direction until the head arrives at a third preliminary position at which the first sensor having turned to the ON state by the head having arrived at the first preliminary position turns to the OFF state again, so as to move the head at the first velocity toward the one end, and rotate the stepping motor by a step number S₃ in the one direction from a point in time at which the head has arrived at the third preliminary position so as to move the head to the third position at the second velocity.

According to a second aspect of the present disclosure, there is provided a head moving method to be executed by a controller of an image forming system including:
a head configured to form an image on a medium by ejecting a liquid;
a head moving mechanism configured to move the head along a head movement direction between an image formation area at one end in the head movement direction and an escape area at other end in the head movement direction, the head moving mechanism including:
   a carriage supporting the head;
   a stepping motor;
   a power transmitter which is connected to the carriage and the stepping motor and which is configured to transmit a power of the stepping motor to the carriage; and
   a first sensor and a second sensor each configured to sense that the head is located in the image formation area, and each configured to be in an OFF state in a case where the head is located in the escape area; and
the controller electrically connected to the stepping motor, the first sensor, and the second sensor,
the head moving method including:
in a case where the head is moved from the escape area to a first position in the image formation area, rotate the stepping motor in one direction until the head arrives at a first preliminary position at which the first sensor turns from the OFF state to an ON state, so as to move the head at a first velocity toward the one end, and rotate the stepping motor by a step number S₁ in the one direction from a point in time at which the head has arrived at the first preliminary position, so as to move the head to the first position at a second velocity smaller than the first velocity, by the controller;
in a case where the head is moved from the escape area to a second position, in the image formation area, different from the first position, rotate the stepping motor in the one direction until the head arrives at a second preliminary position at which the second sensor turns from the OFF state to the ON state, so as to move the head at the first velocity toward the one end, and rotate the stepping motor by a step number S₂ in the one direction from a point in time at which the head has arrived at the second preliminary position, so as to move the head to the second position at the second velocity, by the controller; and
in a case where the head is moved from the escape area to a third position, in the image formation area, different from the first position and the second position, rotate the stepping motor in the one direction until the head arrives at a third preliminary position at which the first sensor having turned to the ON state by the head having arrived at the first preliminary position turns to the OFF state again, so as to move the head at the first velocity toward the one end, and rotate the stepping motor by a step number S₃ in the one direction from a point in time at which the head has arrived at the third preliminary position so as to move the head to the third position at the second velocity, by the controller.

Based on an image forming system and a head moving method according to the disclosure, a user of the system and the method can move a head quickly and precisely to each of a plurality of image formation positions.

### BRIEF DESCRIPTION OF DRAWINGS

FIG. 1 is a schematic view of a configuration of a printer.

FIG. 2 is a schematic view of a configuration of the printer as seen in a medium widthwise direction.

FIG. 3A is a perspective view of a head assembly. FIG. 3B is a top view of the head assembly.

FIG. 4 is a schematic view of the positional relationships in the medium widthwise direction among a head unit, a platen, and a maintenance unit. Note that only heads, which are included in a plurality of heads and disposed upstream in a conveyance direction, are depicted. Further, regarding wipers and nozzle caps corresponding to the plurality of heads, only a wiper and nozzle caps corresponding to the depicted heads are depicted.

FIG. 5 is a schematic side view of a moving mechanism as seen from the left in the medium widthwise direction. In FIG. 5, a curve of a carriage along the conveyance direction is omitted from the illustration.

FIG. 6A and FIG. 6B each illustrates the moving mechanism as seen from the downstream in the conveyance direction. FIG. 6A depicts the moving mechanism in a state that the head unit is located at a printing position, and FIG. 6B depicts the moving mechanism in a state that the head unit is located at a maintenance position. Note that for the convenience of description, a shaft of a stepping motor, a pinion gear fixed to the shaft, and a rack gear meshed with the pinion gear are also depicted in the drawing. However, in a case where the moving mechanism is seen from the downstream in the conveyance direction, these parts are not visually recognized.

FIG. 7 is a functional block diagram of electric configuration of the printer.

FIG. 8 is a top view depicting a relationship between the head assembly and a medium placement area regarding each of three printing positions. The upper part of FIG. 8 depicts the relationship between the medium placement area and the head assembly located at a right printing position. The middle part of FIG. 8 depicts the relationship between the medium placement area and the head assembly located at a central printing position. The lower part of FIG. 8 depicts the relationship between the medium placement area and the head assembly located at a left printing position.

FIG. 9A to FIG. 9F each depicts the positional relationship in the medium widthwise direction between a sensing target plate fixed to the carriage, and a left sensor and a right sensor which are fixed to a casing. FIG. 9A depicts the positional relationship in a case where the head assembly is located at a right sensor light-shielded position, and FIG. 9B depicts the positional relationship in a case where the head assembly is located at the right printing position. FIG. 9C depicts the positional relationship in a case where the head assembly is located at a left sensor light-shielded position, and FIG. 9D depicts the positional relationship in a case where the head assembly is located at the central printing position. FIG. 9E depicts the positional relationship in a case where the head assembly is located at a right sensor light re-receiving position, and FIG. 9F depicts the positional relationship in a case where the head assembly is located at the left printing position. In the respective drawings, solid circles each indicate that the sensor is in a light-shielded state, and blank circles each indicate that the sensor is in a light-receiving state.

FIG. 10 is a view illustrating positional relationships of the right printing position, the central printing position, the left printing position, the right sensor light-shielded position, the left sensor light-shielded position, and the right sensor light re-receiving position, and illustrating a movement velocity to be adopted in a case where the head assembly is moved to each of the right printing position, the central printing position, and the left printing position.

FIG. 11 is a flow chart of a procedure of initial adjustment of the printer.

FIG. 12 is a side view of a moving mechanism according to a comparative example as seen from the downstream in the conveyance direction. In the same manner as FIG. 6A, a shaft of a stepping motor, a pinion gear fixed to the shaft, and a rack gear meshed with the pinion gear are also depicted in the drawing. However, in a case where the moving mechanism is seen from the downstream in the conveyance direction, these parts are not visually recognized.

FIG. 13A to FIG. 13F each depict the positional relationship in the medium widthwise direction between a sensing target plate fixed to a carriage, and a left sensor and a right sensor fixed to a casing respectively. FIG. 13A depicts the positional relationship in a case where the head assembly is located at a right sensor light-shielded position, and FIG. 13B depicts the positional relationship in a case where the head assembly is located at the right printing position. FIG. 13C depicts the positional relationship in a case where the head assembly is located at a right sensor light re-receiving position, and FIG. 13D depicts the positional relationship in a case where the head assembly is located at the central printing position. FIG. 13E depicts the positional relationship in a case where the head assembly is located at a left sensor light-shielded position, and FIG. 13F depicts the positional relationship in a case where the head assembly is located at the left printing position. In the respective drawings, solid circles each indicate that the sensor is in the light-shielded state, and blank circles each indicate that the sensor is in the light-receiving state.

FIG. 14 is a view illustrating the positional relationship among the right printing position, the central printing position, the left printing position, the right sensor light-shielded position, the right sensor light re-receiving position, and the left sensor light-shielded position, and illustrating a movement velocity to be adopted in a case where the head assembly is moved to each of the right printing position, the central printing position, and the left printing position.

### DESCRIPTION OF EMBODIMENT

### Embodiment

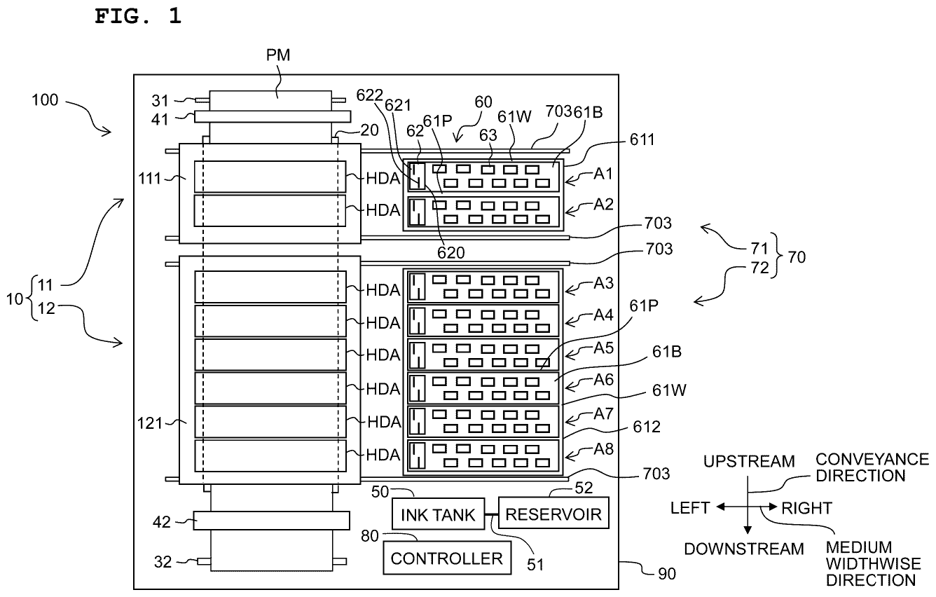

A printer (image forming system) 100 as an embodiment of the present disclosure will be described with reference to FIG. 1 to FIG. 12.

### (Printer 100)

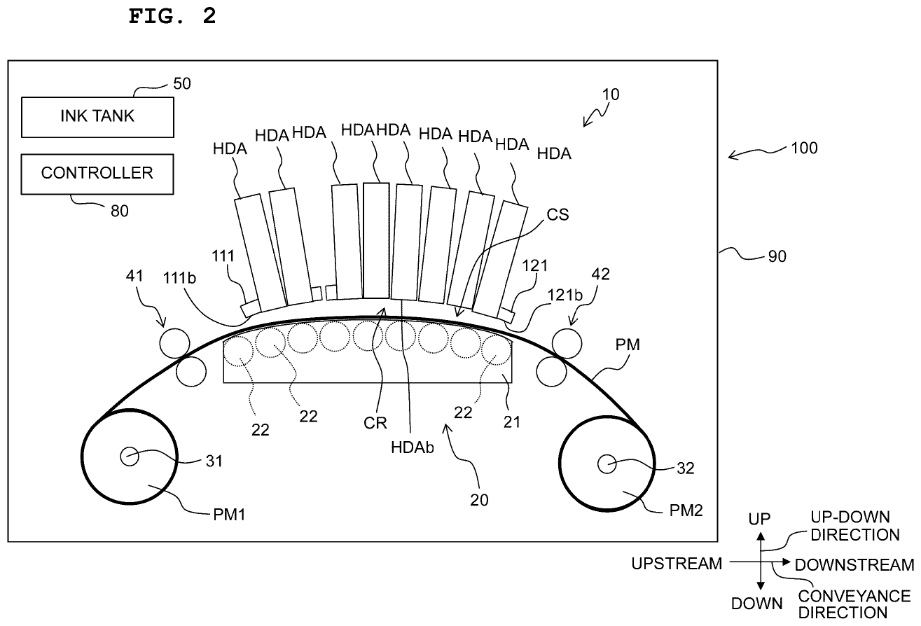

As depicted in FIG. 1 and FIG. 2, the printer 100 mainly includes a head unit 10, a platen 20, a feeding shaft 31, a winding shaft 32, conveyance roller pairs 41, 42, an ink tank 50, a maintenance unit 60, a moving mechanism 70, a controller 80, and a casing 90 which accommodates those components.

In the following description, the direction in which the conveyance roller pairs 41, 42 are disposed side by side, i.e., the direction in which the medium PM is conveyed during the image formation, is referred to as “conveyance direction” of the printer 100. As for the conveyance direction, the upstream and the downstream of the direction in which the medium PM is conveyed are referred to as “upstream” and “downstream” in the conveyance direction, respectively. Further, the direction, which is orthogonal to the conveyance direction in a horizontal plane, i.e., the direction in which the rotation shafts of the conveyance roller pairs 41, 42 extend, is referred to as “medium widthwise direction”. As for the medium widthwise direction, the left and the right, which are defined in a case where the upstream is seen from the downstream in the conveyance direction, are referred to as “left” and “right” in the medium widthwise direction, respectively. The medium widthwise direction is an example of “head movement direction”.

The head unit 10 includes a first head unit 11 and a second head unit 12. The second head unit 12 is positioned downstream in the conveyance direction of the first head unit 11.

The first head unit 11 has two head assemblies HDA, and a carriage 111 which holds the two head assemblies HDA. The two head assemblies HDA have the mutually same structures. The two head assemblies HDA are integrally held by the carriage 111 while being disposed side by side in the conveyance direction.

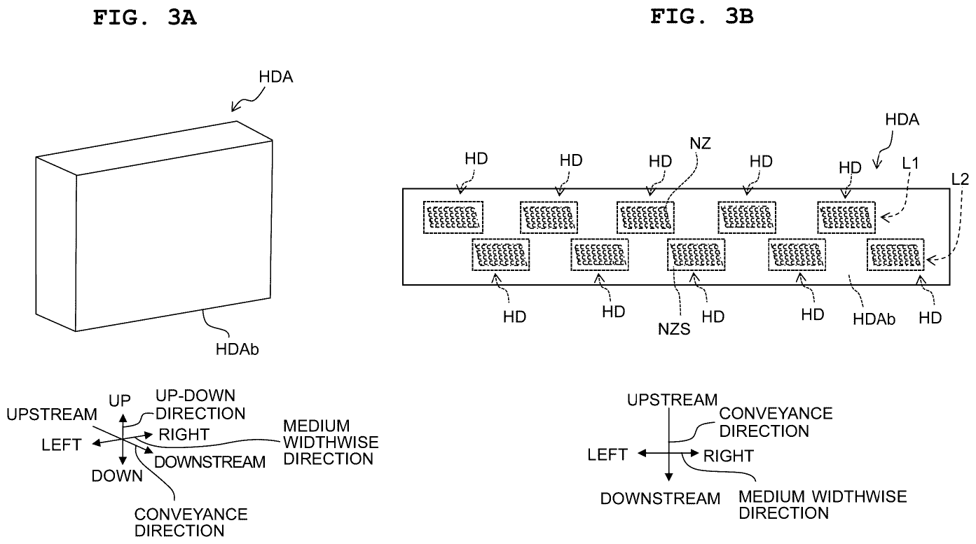

Each of the two head assemblies HDA is a head of the so-called line type (head bar). Each of the two head assemblies HDA is box-shaped (FIG. 3A), and has ten heads HD which are positioned on a lower surface HDAb (FIG. 3B). The ten heads HD have the mutually same structures.

The ten heads HD are positioned in a staggered (zigzag) form in the medium widthwise direction. Specifically, the ten heads HD include five heads HD which are arranged in the medium widthwise direction to construct a first array L1, and five heads HD which are arranged in the medium widthwise direction to construct a second array L2. The second array L2 is positioned downstream in the conveyance direction of the first array L1. The heads HD, which construct the second array L2, are positioned while being shifted rightward in the medium widthwise direction with respect to the heads HS which construct the first array L1.

Flow passages (not depicted in the drawings), which supply an ink supplied from the ink tank 50 to the respective ten heads HD, are formed in each of the two head assemblies HDA.

The lower surface of each of the ten heads HD is a nozzle surface NZS in which a plurality of nozzles NZ are formed. Each of the plurality of nozzles NZ is a minute aperture via which the ink is ejected toward the medium PM. For the convenience of description, thirty-six nozzles NZ are assumed to be formed in each of the heads HD of the present embodiment. The thirty-six nozzles construct four nozzle arrays which are disposed side by side in the conveyance direction. Each of the nozzle arrays includes nine nozzles NZ which are disposed side by side in the medium widthwise direction. The resolution of image formation per each nozzle array is 150 dpi. The resolution of image formation of the head HD having the four nozzle arrays is 600 dpi. Note that the number of nozzles NZ included in the head HD may be greater than thirty-six. The number of nozzle arrays may be greater than four. Further, the resolution of image formation of the head HD may be greater than 600 dpi. For example, the resolution of image formation of the head HD may be increased by increasing the number of nozzle arrays included in the heads HD while decreasing the resolution of each of the nozzle arrays to be smaller than 150 dpi.

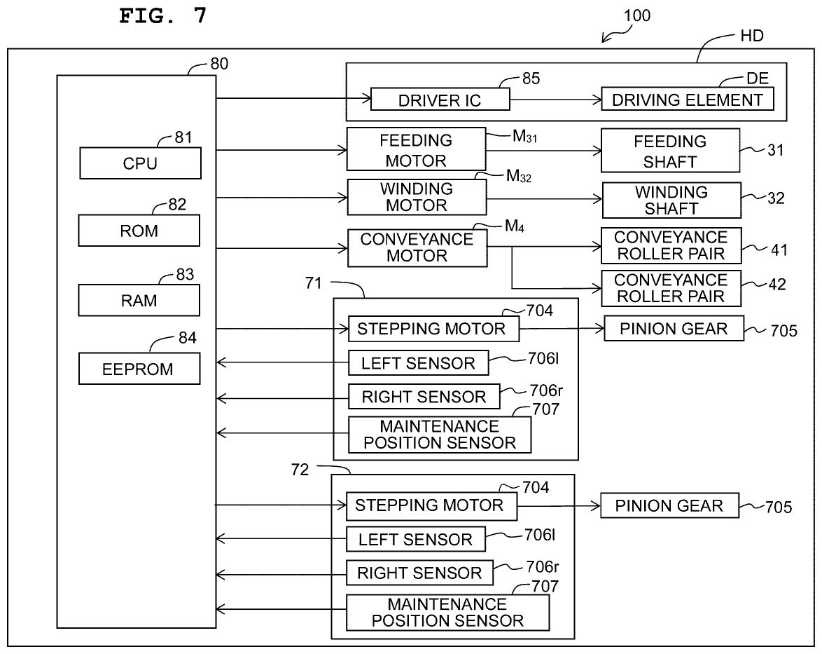

A plurality of individual flow passages (not depicted in the drawings) are formed in each of the ten heads HD. The ink, which flows from the head assembly HDA to each of the ten heads HD, flows to each of the plurality of nozzles NZ via one of the plurality of individual flow passages. Pressure chambers (not depicted in the drawings) are each included in one of the plurality of individual flow passages (not depicted in the drawings) and is located in the vicinity of one of the nozzles NZ corresponding thereto. A driving element DE (FIG. 7) is positioned over each of the pressure chambers. Each of the driving elements DE is connected to the controller 80 via driver IC 85 (FIG. 7).

As depicted in FIG. 2, the carriage 111 has a plate-shaped form which is curved along the conveyance direction. Each of the two head assemblies HDA is held by the carriage 111 in a state that an area, of the head assembly HDA, in the vicinity of the lower end of the head assembly HDA, is fitted to an opening (not depicted in the drawings) formed in the carriage 111.

The carriage 111 holds the two head assemblies HDA so that the up-down directions of the respective two head assemblies HDA (i.e., the directions in which the ink is ejected by the respective head assemblies HDA) are different from each other. Therefore, each of the two head assemblies HDA ejects ink droplets perpendicularly with respect to the medium PM conveyed in a conveyance route CR (details will be described later) which is curved along the conveyance direction.

The second head unit 12 (FIG. 1) has six head assemblies HDA, and a carriage 121 which holds the six head assemblies HDA. Each of the six head assemblies HDA has the same structure as that of each of the two head assemblies HDA held by the first head unit 11. The six head assemblies HDA are integrally held by the carriage 121 while being disposed side by side in the conveyance direction.

As depicted in FIG. 2, the carriage 121 has a plate-shaped form which is curved along the conveyance direction. Each of the six head assemblies HDA is held by the carriage 121 in a state that an area, of the head assembly HDA, in the vicinity of the lower end of the head assembly HDA, is fitted to an opening (not depicted in the drawings) formed in the carriage 121.

The carriage 121 holds the six head assemblies HDA so that the up-down directions of the respective six head assemblies HDA (i.e., the directions in which the ink is ejected by the respective head assemblies HDA) are slightly different from each other. Therefore, each of the six head assemblies HDA ejects ink droplets perpendicularly with respect to the medium PM conveyed in the conveyance route CR (details will be described later) which is curved along the conveyance direction.

In the present embodiment, the carriage 111 and the two head assemblies HDA of the first head unit 11 are vertically movable by an unillustrated lifting mechanism. Further, the carriage 121 and the six head assemblies HDA of the second head unit 12 are vertically movable by an unillustrated lifting mechanism. That is, regarding the eight head assemblies HDA, the height of the nozzle surface NZS can be changed with respect to a conveying surface CS (FIG. 2, details will be described later). A moving mechanism, which is described, for example, in Japanese Patent Application Laid-Open No. 2022-142275, can be used as the lifting mechanism configured to vertically move the eight head assemblies HDA.

The platen 20 supports the medium PM at a position below the medium PM, in a case where the first head unit 11 and the second head unit 12 of the head unit 10 eject the ink toward the medium PM. As depicted in FIG. 2, the platen 20 has an arch frame 21 and a plurality of rollers 22 which are rotatably held by the arch frame 21.

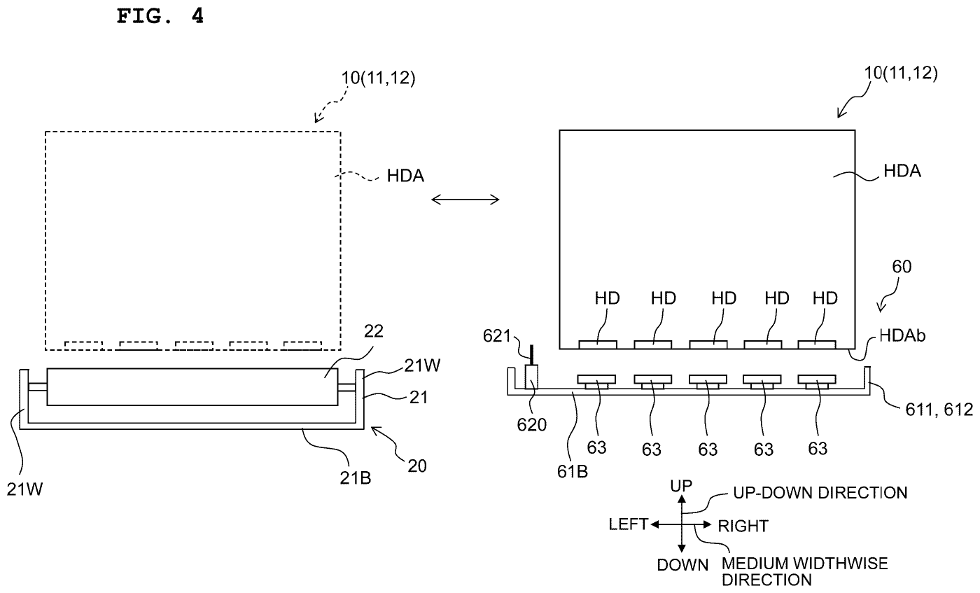

As depicted in FIG. 4, the arch frame 21 has a bottom part 21B and a pair of wall parts 21W which extend upward from both ends in the medium widthwise direction of the bottom part 21B.

The plurality of rollers 22 mutually have the same shape and the same dimension. The plurality of rollers 22 are disposed side by side in the conveyance direction and are held by the arch frame 21, with the rotation shafts (not depicted in the drawings) of the respective rollers 22 being coincident with the medium widthwise direction. In the present embodiment, the plurality of rollers 22 is held by the arch frame 21 so that upper ends of the respective rollers 22 are positioned on a curved surface which is curved in the conveyance direction. The conveying surface CS (FIG. 2), which is curved in the conveyance direction, is defined by the upper ends of the plurality of rollers 22.

As depicted in FIG. 2, the head unit 10 and the platen 20 are positioned so that the lower surface HDAb of each of the head assemblies HDA is opposed to the conveying surface CS. The conveyance route CR, which is curved in the conveyance direction, is defined between the lower surfaces HDAb of the head assemblies HDA and the conveying surface CS.

The feeding shaft 31 is a rotary shaft which is rotatable by a feeding motor M₃₁ (FIG. 7), and the winding shaft 32 is a shaft which is rotatable by a winding motor M₃₂ (FIG. 7). A feeding roll PM1 (FIG. 2) which is the medium PM, before the image formation is performed thereon, wound in a roll form, is attached to the feeding shaft 31. A winding roll PM2 (FIG. 2) which is the medium PM, after the image formation has been performed thereon, wound in a roll form, is attached to the winding shaft 32.

The medium PM, which is fed from the feed roll PM1, is wound into the winding roll PM2 after the image formation has been performed thereon by the head unit 10. For example, a roll sheet can be used as the medium PM.

The conveyance roller pairs 41, 42 (FIG. 1) are positioned while interposing the platen 20 therebetween in the conveyance direction. Each of the conveyance roller pairs 41, 42 is rotated by the driving force transmitted from a conveyance motor M₄ (FIG. 7). In a case where the head unit 10 forms an image on the medium PM, the conveyance roller pairs 41, 42 feed the medium PM to the downstream in the conveyance direction.

The ink tank 50 (FIG. 1) is partitioned into seven parts so that inks of seven colors (seven types) can be accommodated. The inks of seven colors are fed to a reservoir 52 via a tube channel 51. The tube channel 51 and the reservoir 52 are also partitioned into seven parts so that the inks of seven colors can be flown and accommodated. The ink of each color fed to the reservoir 52 is circulated between the reservoir 52 and one of the eight head assemblies HDA via an unillustrated tube channel and an unillustrated pump.

In the present embodiment, the white ink is fed to the two head assemblies HDA of the first head unit 11. Further, the inks of six colors are fed to the six head assemblies HDA of the second head unit 12. The inks of six colors are, for example, black ink, cyan ink, magenta ink, yellow ink, orange ink, and violet ink.

The maintenance unit 60 (FIG. 1) is a mechanism which is configured to perform maintenance for the head unit 10. Specifically, for example, the maintenance of the head unit 10 may include wiping of the head HD, flushing for removing a foreign matter (bubble, particle, etc.) by ejecting the ink from the nozzle NZ, and purging for removing a foreign matter by sucking the ink from the nozzle NZ.

The maintenance unit 60 is positioned in a state in which the maintenance unit 60 is disposed side by side with the platen 20 in the medium widthwise direction. In the present embodiment, the maintenance unit 60 is positioned on the right of the platen 20.

The maintenance unit 60 has a first maintenance pan 611, a second maintenance pan 612, eight wiper units 62, and eighty nozzle caps 63.

The first maintenance pan 611 and the second maintenance pan 612 are flat dish-shaped members configured to receive the inks fallen from the first head unit 11 and the second head unit 12, respectively. Each of the first maintenance pan 611 and the second maintenance pan 612 has a bottom part 61B, a circumferential wall 61W which stands upright from the circumferential edge of the bottom part 61B, and a separation wall 61P which extends in the medium widthwise direction to connect one side and the other side of the circumferential wall 61W.

The bottom part 61B of the first maintenance pan 611 has a rectangular shape as seen in a plan view, and the bottom part 61B of the first maintenance pan 611 is partitioned by one separation wall 61P into two areas A1, A2. The bottom part 61B of the second maintenance pan 612 has a rectangular shape as seen in a plan view, and the bottom part 61B of the second maintenance pan 612 is partitioned by five separation walls 61P into six areas A3 to A8.

Each of the eight wiper units 62 performs the wiping of the heads HD of the eight head assemblies HDA of the head unit 10. The eight wiper units 62 are positioned one by one in the areas A1 to A8 of the bottom parts 61B of the first maintenance pan 611 and the second maintenance pan 612. The eight wiper units 62 have the mutually same structures.

Each of the eight wiper units 62 has a base 620, and a first wiper 621 and a second wiper 622 supported by the base 620.

The base 620 is a pedestal-shaped structure which is positioned in the vicinity of the left end in the medium widthwise direction in each of the areas A1, A2 of the bottom part 61B of the first maintenance pan 611 and the areas A3 to A8 of the bottom part 61B of the second maintenance pan 612.

The first wiper 621 is a wiper configured to wipe the nozzle surfaces NZS of the heads HD in the first array L1 of the corresponding head assembly HDA. The second wiper 622 is a wiper configured to wipe the nozzle surfaces NZS of the heads HD in the second array L2 of the corresponding head assembly HDA. The second wiper 622 is positioned at the right in the medium widthwise direction and on the downstream in the conveyance direction of the first wiper 621. Each of the first wiper 621 and the second wiper 622 is formed of a flexible material (for example, rubber). The first wiper 621 and the second wiper 622 have the mutually same shapes.

The eighty nozzle caps 63 cover, respectively, the eighty heads HD of the head unit 10, for example, in order to prevent the inks from being dried. The eighty nozzle caps 63 have the mutually same structures. The eighty nozzle caps 63 are positioned on the bottom parts 61B of the first maintenance pan 611 and the second maintenance pan 612. Specifically, the ten nozzle caps 63 are positioned in a zigzag form along the medium widthwise direction, and at the right of each of the wiper units 62 of the areas A1 to A8.

In a case where the first head unit 11 is located over the first maintenance pan 611 or in a case where the second head unit 12 is located over the second maintenance pan 612 (FIG. 4), the respective nozzle caps 63 are positioned immediately under the corresponding heads HD. In this state, the two head assemblies HDA of the first head unit 11 or the six head assemblies HDA of the second head unit 12 are vertically moved by the unillustrated lifting mechanism so as to displace between a covered state in which the nozzle caps 63 make contact with the heads HD to cover the nozzles NZ of the heads HD and an uncovered state in which the nozzle caps 63 are separated from the heads HD.

The moving mechanism 70 (FIG. 1) is a mechanism which displaces the head unit 10 between a printing position at which the head unit 10 executes the printing and a maintenance position at which the maintenance is executed. The head unit 10 (first head unit 11 and second head unit 12), which is located at the printing position, is depicted by broken lines in FIG. 4. The head unit 10, which is located at the maintenance position, is depicted by solid lines in FIG. 4.

As depicted in FIG. 1, the moving mechanism 70 has a first moving mechanism 71 configured to move the first head unit 11 and a second moving mechanism 72 configured to move the second head unit 12.

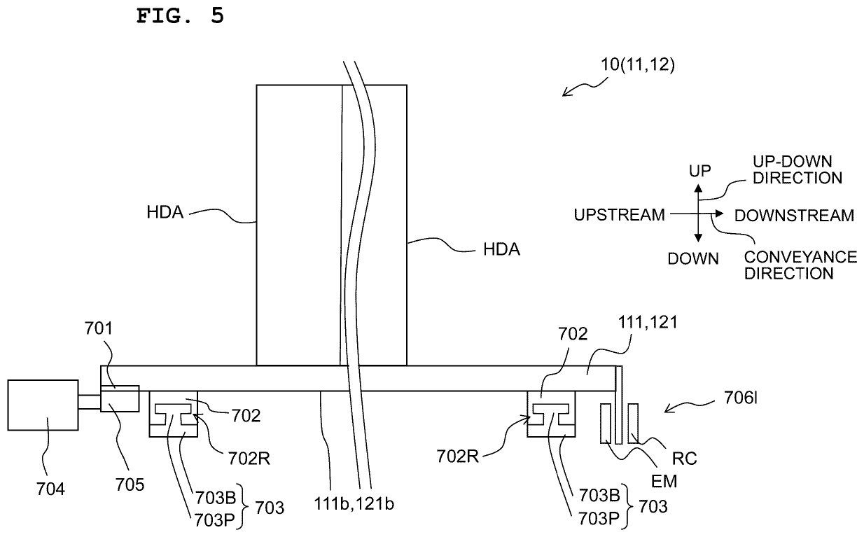

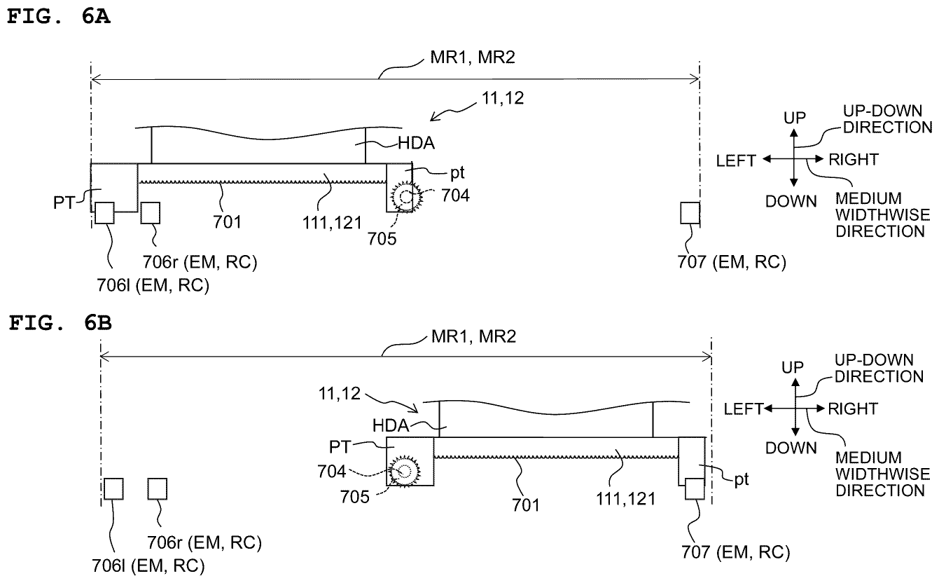

As depicted in FIG. 5, FIG. 6A, and FIG. 6B, the first moving mechanism 71 mainly includes a rack gear 701, a pair of guided parts 702, a pair of guide rails 703, a stepping motor 704, a pinion gear 705, a left sensor 7061, a right sensor 706r, and a maintenance position sensor 707. The rack gear 701 and the pinion gear 705 are an example of “power transmitter”. The left sensor 7061 is an example of “second sensor”, and the right sensor 706r is an example of “first sensor”. The maintenance position sensor 707 is an example of “third sensor”.

As depicted in FIG. 5, the rack gear 701 is positioned at an upstream end in the conveyance direction of a lower surface 111b of the carriage 111 of the first head unit 11. The direction, in which gear teeth of the rack gear 701 are aligned, is the medium widthwise direction.

The pair of guided parts 702 are positioned in the lower surface 111b of the carriage 111 of the first head unit 11. One guided part 702 is positioned in the vicinity of the upstream end in the conveyance direction of the lower surface 111b, and the other guided part 702 is positioned in the vicinity of the downstream end in the conveyance direction of the lower surface 111b. Each of the pair of guided parts 702 is a long member. The cross section, which is orthogonal to the longitudinal direction, of each of the pair of guide target parts 702 has a shape which is a substantially C-shaped form having a recess 702R. Each of the pair of guided parts 702 is positioned so that the direction of the longitudinal direction thereof is parallel to the medium widthwise direction.

The pair of guide rails 703 are positioned under the first head unit 11. One guide rail 703 is positioned in the vicinity of the upstream end in the conveyance direction of the first head unit 11, and the other guide rail 703 is positioned in the vicinity of the downstream end in the conveyance direction of the first head unit 11. Each of the pair of guide rails 703 is a long member. The cross-section, which is orthogonal to the longitudinal direction, of each of the pair of guide rails 703 has a shape which has a base 703B and a T-shaped protrusion 703P. Each of the pair of guide rails 703 is positioned so that the longitudinal direction thereof is parallel to the medium widthwise direction.

The pair of guided parts 702 and the pair of guide rails 703 are engaged with each other in a state that the protrusions 703P of the guide rails 703 are positioned, respectively, in the recesses 702R of the guided parts 702.

The stepping motor 704 is positioned upstream in the conveyance direction of the first head unit 11. As depicted in FIG. 6A and FIG. 6B, the stepping motor 704 is positioned in the medium widthwise direction at a substantially central portion of a movable range MR1 of the first head unit 11 which is movable between the printing position and the maintenance position.

The pinion gear 705 is fixed to a rotation shaft of the stepping motor 704. The pinion gear 705 is fitted to the rack gear 701 included in the carriage 111.

In a case where the stepping motor 704 is driven to cause the pinion gear 705 to rotate, the first head unit 11 moves in the medium widthwise direction by the fitting between the pinion gear 705 and the rack gear 701. The first head unit 11 moves in the medium widthwise direction in a state in which the guided parts 702 are supported and guided by the guide rails 703.

The left sensor 7061 and the right sensor 706r (FIG. 6A, FIG. 6B) are, respectively, sensors for positioning the carriage 111 at any one of the three printing positions (i.e., right printing position, central printing position, and left printing position, which will be described in detail later). The left sensor 7061 is positioned in the vicinity of the left end of the movable range MR1 of the carriage 111, and the right sensor 706r is positioned at the right of the left sensor 7061. Each of the left sensor 7061 and the right sensor 706r is positioned on a frame (not depicted in the drawings) fixed to the casing 90.

Each of the left sensor 7061 and the right sensor 706r is an optical sensor having a light-emitting part EM which emits a light and a light-receiving part RC which receives the light from the light-emitting part EM. In the present embodiment, the light-emitting part EM and the light-receiving part RC are opposed to each other in the conveyance direction. The light-emitting part EM emits the light in the conveyance direction.

The maintenance position sensor 707 is a sensor for positioning the carriage 111 at the maintenance position. The maintenance position sensor 707 is positioned in the vicinity of the right end of the movable range MR1 of the carriage 111. The maintenance position sensor 707 is positioned on the frame (not depicted in the drawings) fixed to the casing 90.

The maintenance position sensor 707 is also an optical sensor having a light-emitting part EM which emits a light and a light-receiving part RC which receives the light from the light-emitting part EM, in the same manner as the left sensor 7061 and the right sensor 706r. In the present embodiment, the light-emitting part EM and the light-receiving part RC are opposed to each other in the conveyance direction. The light-emitting part EM emits the light in the conveyance direction.

The first moving mechanism 71 further includes a sensing target plate PT which is sensed by the left sensor 7061 and the right sensor 706r, and a sensing target plate pt which is sensed by the maintenance position sensor 707 (FIG. 6A, FIG. 6B). The sensing target plate PT and the sensing target plate pt are flat plates, respectively, which are fixed to the end surface on the downstream side in the conveyance direction of the carriage 111 and which extend in the plane orthogonal to the conveyance direction. The sensing target plate PT is fixed to the carriage 111 at the left end in the medium widthwise direction. The sensing target plate pt is fixed to the carriage 111 at the right end in the medium widthwise direction.

Each of the left sensor 7061 and the right sensor 706r senses the position of the carriage 111 based on the shielding of the light from the light-emitting part EM by the sensing target plate PT. The maintenance position sensor 707 senses the position of the carriage 111 based on the shielding of the light from the light-emitting part EM by the sensing target plate pt.

The second moving mechanism 72 is configured in the same manner as the first moving mechanism 71 except that the target to be moved is the carriage 121 of the second head unit 12, rather than the carriage 111 of the first head unit 11.

As depicted in FIG. 5, in the second moving mechanism 72, a rack gear 701 is positioned at an upstream end in the conveyance direction of a lower surface 121b of the carriage 121 of the second head unit 12. A stepping motor 704 of the second moving mechanism 72 is positioned upstream in the conveyance direction of the second head unit 12. A pair of guided parts 702 of the second moving mechanism 72 are positioned in the lower surface 121b of the carriage 121 of the second head unit 12. One guided part 702 is positioned in the vicinity of the upstream end in the conveyance direction of the lower surface 121b, and the other guided part 702 is positioned in the vicinity of the downstream end in the conveyance direction of the lower surface 121b.

A left sensor 7061 and a right sensor 706r of the second moving mechanism 72 (FIG. 6A, FIG. 6B) are, respectively, sensors for positioning the carriage 121 at any one of the three printing positions. The left sensor 7061 is positioned in the vicinity of the left end of a movable range MR2 of the carriage 121, and the right sensor 706r is positioned at the right of the left sensor 7061.

A maintenance position sensor 707 of the second moving mechanism 72 is a sensor for positioning the carriage 121 at the maintenance position. The maintenance position sensor 707 is positioned in the vicinity of the right end of the movable range MR2 of the carriage 121.

A sensing target plate PT and a sensing target plate pt of the second moving mechanism 72 are flat plates, respectively, which are fixed to the end surface on the downstream side in the conveyance direction of the carriage 121 and which extend in the plane orthogonal to the conveyance direction. The sensing target plate PT is fixed to the carriage 121 at the left end in the medium widthwise direction. The sensing target plate pt is fixed to the carriage 121 at the right end in the medium widthwise direction.

The controller 80 (FIG. 7) controls the respective parts of the printer 100 as a whole. The controller 80 is connected to an external apparatus such as PC, etc. (not depicted) so that the controller 80 can perform data communication with the external apparatus. The controller 80 controls the respective parts of the printer 100 based on printing data transmitted from the external apparatus to thereby form an image corresponding to the printing data on the medium PM.

The controller 80 has CPU 81, ROM 82, RAM 83, and EEPROM 84. The ROM 82 stores, for example, various data required for the operation of the controller 80. The RAM 83 is a working memory for the CPU 81. The EEPROM 84 stores, for example, control programs to be executed by the CPU 81.

The controller 80 is connected, via ASIC (not depicted), to driver IC 85 of the head HD, the feeding motor M₃₁, the winding motor M₃₂, the conveyance motor M₄, the stepping motor 704 of the first moving mechanism 71, and the stepping motor 704 of the second moving mechanism 72. The controller 80 is further connected to the left sensor 7061, the right sensor 706r, and the maintenance position sensor 707 of each of the first moving mechanism 71 and the second moving mechanism 72.

### (Printing Method)

The printing (image formation) on the medium PM by using the printer 100 is performed as follows.

In the printing on the medium PM by the printer 100, the controller 80 controls the respective parts of the printer 100 so that the printer 100 executes a conveying step of conveying the medium PM in the conveyance direction, and an ejecting step of ejecting the ink(s) onto the medium PM from the head unit 10.

In the conveying step, the controller 80 drives the feeding motor M₃₁, the winding motor M₃₂, and the conveyance motor M₄ to rotate the feeding shaft 31, the winding shaft 32, and the conveyance roller pairs 41, 42, thereby feeding the medium PM to the downstream in the conveyance direction.

In the ejecting step, the controller 80 drives the driving element DE in a mode corresponding to the printing data received from the external apparatus such as PC, etc., thereby ejecting ink droplets from the head(s) HD toward the medium PM supported by the conveying surface CS in the conveyance route CR. The ink droplets land on the medium PM, and thus an image corresponding to the printing data is formed on the medium PM.

The controller 80 causes the printer 100 to execute the conveying step and the ejecting step in parallel, thereby forming the image progressively on the medium PM.

### (Movement of Head Assembly HDA to Printing Position)

The printer 100 of the present embodiment uses the three printing positions as the positions of the head assembly HDA in a case where the printing is performed on the medium PM (i.e., the positions of the head assembly HDA in a case where the image is formed on the medium PM by performing the ejection process). The three printing positions are the right printing position, the central printing position, and the left printing position.

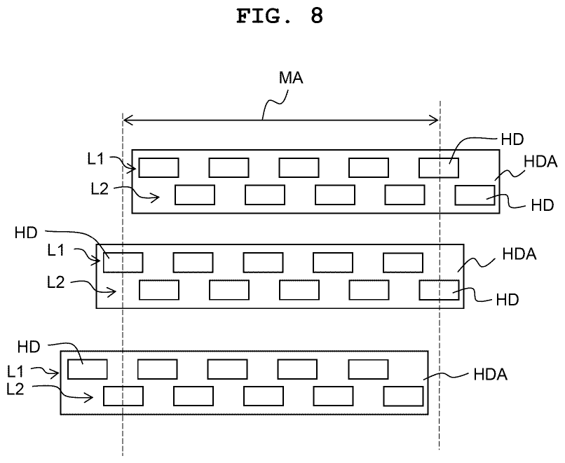

In a case where the head assembly HDA is located at the right printing position (upper part of FIG. 8), an area, of the head HD disposed at the right end of the first array L1, located at the right of the medium placement area MA (i.e., an area, on the conveying surface CS, on which the medium PM can be placed), and the entirety of the head HD disposed at the right end of the second array L2 are located at the right of and outside of the medium placement area MA. Note that the dimension in the medium widthwise direction of the medium placement area MA means the maximum value in the medium widthwise direction of the medium PM which can be conveyed via the conveyance route CR.

In a case where the head assembly HDA is located at the central printing position (middle part of FIG. 8), an area, of the head HD disposed at the left end of the first array L1, located at the left of the medium placement area MA, and an area, of the head HD disposed at the right end of the second array L2, located at the right of the medium placement area MA are located outside the medium placement area MA. In a case where the head assembly HDA is located at the central printing position, the central position in the medium widthwise direction of the head assembly HDA (central position of an area ranging from the nozzle NZ disposed at the left end of the head HD disposed at the left end to the nozzle NZ disposed at the right end of the head HD disposed at the right end) is coincident with the central position in the medium widthwise direction of the medium placement area MA.

In a case where the head assembly HDA is located at the left printing position (lower part of FIG. 8), the entirety of the head HD disposed at the left end of the first array L1 and a part, of the head HD disposed at the left end of the second array L2, located to the left of the medium placement area MA are located at the left of and outside of the medium placement area MA. Note that in the present embodiment, regarding the HD only a part of which is located outside the medium placement area MA at each of the printing positions, an area, which has a length of ½ of the length of the head HD in the medium widthwise direction, is located outside the medium placement area MA.

In the present embodiment, each of the distance (shift amount) in the medium widthwise direction between the head assembly HDA located at the right printing position and the head assembly HDA located at the central printing position and the distance (shift amount) in the medium widthwise direction between the head assembly HDA located at the central printing position and the head assembly HDA located at the left printing position is equal to the length of the head HD in the medium widthwise direction. In this specification and in the present invention, the “length of the head in the medium widthwise direction” means the distance in the medium widthwise direction ranging from the nozzle disposed at one end in the medium widthwise direction in the head to the nozzle disposed at the other end in the medium widthwise direction in the head. Note that the distance (shift amount) in the medium widthwise direction between the head assembly HDA located at the right printing position and the head assembly HDA located at the central printing position and the distance (shift amount) in the medium widthwise direction between the head assembly HDA located at the central printing position and the head assembly HDA located at the left printing position may have any values without being limited to the above-described value, and may be different from each other. The right printing position, the central printing position, and the left printing position can be set so that each of the all nozzles NZ included in the head assembly HDA is located in the medium placement area MA in at least one of the three printing positions.

Note that the printer 100 of the present embodiment uses the central printing position, for example, in an ordinary printing process, and the printer 100 uses the right printing position and the left printing position in the initial setting (details will be described later), for the following reason. That is, in the initial setting, the inks are required to be ejected also from the nozzles NZ positioned outside the medium placement area MA in a case where the head assembly HDA is located at the central printing position. Alternatively, the printer 100 of the present embodiment may use the right printing position and the left printing position in the ordinary printing process. For example, in a case where any malfunction such as the ejection failure, etc., is occurred in a part of the nozzles which are to be used in a case where the head assembly HDA is located at the central printing position, the malfunction may be dissolved or reduced by using the right printing position and/or the left printing position.

In the following, the description will be made regarding the movement of the head assembly HDA from the maintenance position to each of the right printing position, the central printing position, and the left printing position, and the movement of the head assembly HDA from one of the right printing position, the central printing position, and the left printing position to the maintenance position. The description will be made regarding an exemplary case in which the controller 80 controls the first moving mechanism 71 to move the head assembly HDA of the first head unit 11. The controller 80 also performs the movement of the head assembly HDA of the second head unit 12 by controlling the second moving mechanism 72, in accordance with the same or similar procedure as that described below. The controller 80 may perform the movement of the head assembly HDA of the first head unit 11 by controlling the first moving mechanism 71 and the movement of the head assembly HDA of the second head unit 12 by controlling the second moving mechanism 72 at the same timing, or at different timings independently from each other.

### (1) Movement to Right Printing Position

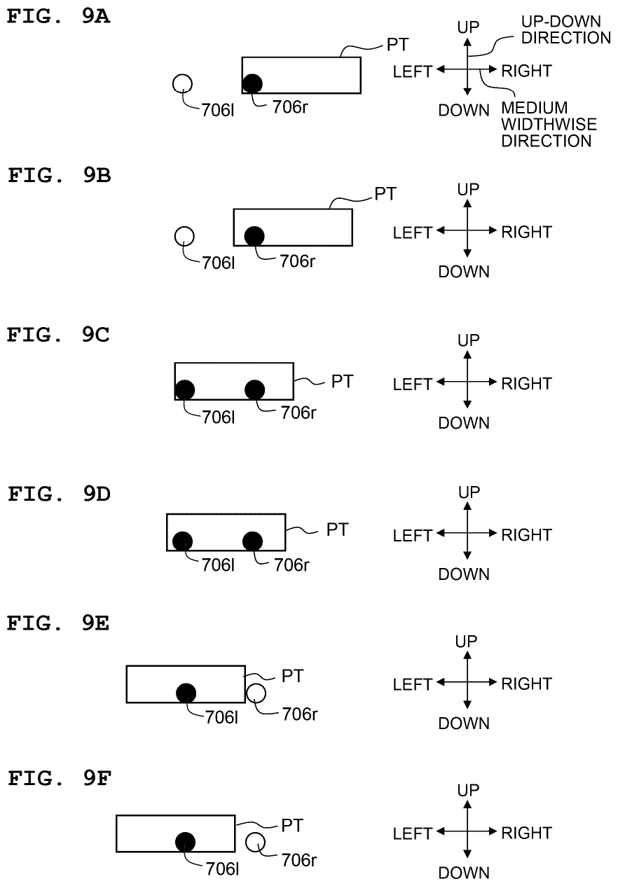

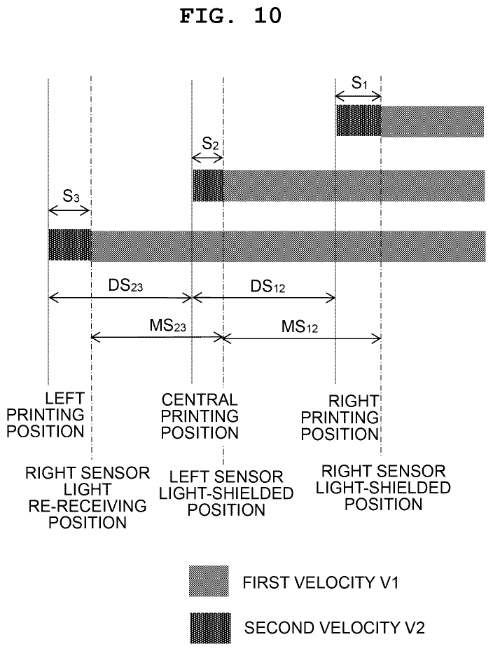

In a case where the controller 80 moves the head assembly HDA of the first head unit 11 from the maintenance position to the right printing position (as illustrated in the upper part of FIG. 8), the controller 80 firstly rotates the stepping motor 704 of the first moving mechanism 71 in the forward direction to move the carriage 111 (and consequently the head assembly HDA) leftward in the medium widthwise direction. The controller 80 moves the carriage 111 leftward in the medium widthwise direction at a first velocity V1 until the carriage 111 arrives at a position (FIG. 9A) at which the sensing target plate PT fixed to the carriage 111 shields the light from the light-emitting part EM of the right sensor 706r and the state of the right sensor 706r is changed from a light-receiving state to a light-shielded state. The light-receiving state of the sensor 706r, 7061 is the state in which the light-receiving part RC of the sensor 706r, 7061 receives the light from the light-emitting part EM, and this state is an example of “OFF state”. The light-shielded state of the sensor 706r, 7061 is the state in which the light-receiving part RC of the sensor 706r, 7061 does not receive the light from the light-emitting part EM, and this state is an example of “ON state”. In the following description, the position, at which the state of the right sensor 706r is changed from the light-receiving state to the light-shielded state, is referred to as “right sensor light-shielded position” (FIG. 10). The controller 80 can determine that the carriage 111 has arrived at the right sensor light-shielded position based on that the signal coming from the right sensor 706r has been changed from the light-receiving signal to the light-shielding signal.

The controller 80 may move the carriage 111 at a constant velocity in the entire area ranging from the maintenance position to the right sensor light-shielded position. Alternatively, the controller 80 may change the velocity of the carriage 111 during the process until the carriage 111 arrives at the right sensor light-shielded position from the maintenance position. For example, the controller 80 may accelerate the carriage 111, which has started the leftward movement from the maintenance position, once to the maximum velocity, and then decelerate the carriage 111 to cause the carriage 111 to arrive at the right sensor light-shielded position. In a case where the velocity of the carriage 111 (head assembly HDA) is a constant velocity in the entire area ranging from the maintenance position to the right sensor light-shielded position, the constant velocity is the first velocity V1. In a case where the velocity of the carriage 111 (head assembly HDA) changes during a process until the carriage 111 (head assembly HDA) arrives at the right sensor light-shielded position from the maintenance position, the average velocity, of the carriage 111 (head assembly HDA) until arrival at the right sensor light-shielded position from the maintenance position, is the first velocity V1.

Subsequently, from a point in time at which the carriage 111 has arrived at the right sensor light-shielded position, the controller 80 rotates the stepping motor 704 by a step number S₁ in the forward direction, at such a rotation speed that the carriage 111 is moved at a second velocity V2 which is smaller than the first velocity V1. With this, the carriage 111 is moved leftward in the medium widthwise direction at the second velocity V2 which is smaller than the first velocity V1, and the carriage 111 arrives at the right printing position. In a case where the carriage 111 is located at the right printing position, the left end of the sensing target plate PT is located between the left sensor 7061 and the right sensor 706r, and the right end of the sensing target plate PT is located to the right of the right sensor 706r. Therefore, the left sensor 7061 is in the light-receiving state, and the right sensor 706r is in the light-shielded state (FIG. 9B).

### (2) Movement to Central Printing Position

In a case where the controller 80 moves the head assembly HDA of the first head unit 11 from the maintenance position to the central printing position (as illustrated in the middle part of FIG. 8), the controller 80 firstly rotates the stepping motor 704 of the first moving mechanism 71 in the forward direction to move the carriage 111 (and consequently the head assembly HDA) leftward in the medium widthwise direction. The controller 80 moves the carriage 111 at the first velocity V1 leftward in the medium widthwise direction until the carriage 111 arrives at a position (FIG. 9C) at which the sensing target plate PT fixed to the carriage 111 shields the light from the light-emitting part EM of the left sensor 7061 and the state of the left sensor 7061 is changed from the light-receiving state to the light-shielded state. In the following description, the position, at which the state of the left sensor 7061 is changed from the light-receiving state to the light-shielded state, is referred to as “left sensor light-shielded position” (FIG. 10). The controller 80 can determine that the carriage 111 has arrived at the left sensor light-shielded position based on that the signal coming from the left sensor 7061 has been changed from the light-receiving signal to the light-shielding signal. Note that in the present embodiment, the dimension of the sensing target plate PT in the medium widthwise direction is greater than the separation distance in the medium widthwise direction between the right sensor 706r and the left sensor 7061. Therefore, the right sensor 706r is also in the light-shielded state at the point in time at which the carriage 111 arrives at the left sensor light-shielded position.

The controller 80 may move the carriage 111 at a constant velocity in the entire area ranging from the maintenance position to the left sensor light-shielded position. Alternatively, the controller 80 may change the velocity of the carriage 111 during the process until the carriage 111 arrives at the left sensor light-shielded position from the maintenance position. In a case where the velocity of the carriage 111 (head assembly HDA) is a constant velocity in the entire area ranging from the maintenance position to the left sensor light-shielded position, the constant velocity is the first velocity V1. In a case where the velocity of the carriage 111 (head assembly HDA) changes during the process until the carriage 111 arrives at the left sensor light-shielded position from the maintenance position, the average velocity, of the carriage 111, until arrival at the left sensor light-shielded position from the maintenance position, is the first velocity V1.

Subsequently, the controller 80 rotates the stepping motor 704 by a step number S₂ in the forward direction at a rotation speed by which the carriage 111 is moved at a second velocity V2 smaller than the first velocity V1, from a point in time at which the carriage 111 has arrived at the left sensor light-shielded position. With this, the carriage 111 is moved leftward in the medium widthwise direction at the second velocity V2 which is smaller than the first velocity V1, and the carriage 111 arrives at the central printing position. In a case where the carriage 111 is located at the central printing position, the left end of the sensing target plate PT is located to the left of the left sensor 7061, and the right end of the sensing target plate PT is located to the right of the right sensor 706r. Therefore, both of the left sensor 7061 and the right sensor 706r are in the light-shielded state (FIG. 9D).

### (3) Movement to Left Printing Position

In a case where the controller 80 moves the head assembly HDA of the first head unit 11 from the maintenance position to the left printing position (as illustrated in the lower part of FIG. 8), the controller 80 firstly rotates the stepping motor 704 of the first moving mechanism 71 in the forward direction to move the carriage 111 (and consequently the head assembly HDA) leftward in the medium widthwise direction. The controller 80 moves the carriage 111 leftward in the medium widthwise direction at the first velocity V1, until the sensing target plate PT fixed to the carriage 111 passes through the light-emitting part EM of the right sensor 706r and the carriage 111 arrives at a position (FIG. 9E) at which the state of the right sensor 706r having changed from the light-receiving state to the light-shielded state is changed to the light-receiving state again. In the following description, a position, at which the state of the right sensor 706r having changed from the light-receiving state to the light-shielded state is changed to the light-receiving state again, is referred to as “right sensor light re-receiving position” (FIG. 10). The controller 80 can determine that the carriage 111 has arrived at the right sensor light re-receiving position based on that the signal from the right sensor 706r has been changed from the light-receiving signal to the light-shielding signal, and then the light-shielding signal has been changed to the light-receiving signal again. Note that in the present embodiment, the left sensor 7061 is in the light-shielded state at the point in time at which the carriage 111 has arrived at the right sensor light re-receiving position.

The controller 80 may move the carriage 111 at a constant velocity in the entire area ranging from the maintenance position to the right sensor light re-receiving position. Alternatively, the controller 80 may change the velocity of the carriage 111 during the process until the carriage 111 arrives at the right sensor light re-receiving position from the maintenance position. In a case where the velocity of the carriage 111 (head assembly HDA) is a constant velocity in the entire area ranging from the maintenance position to the right sensor light re-receiving position, the constant velocity is the first velocity V1. In a case where the velocity of the carriage 111 (head assembly HDA) changes during the process until the carriage 111 arrives at the right sensor light re-receiving position from the maintenance position, the average velocity, of the carriage 111, until arrival at the right sensor light re-receiving position from the maintenance position, is the first velocity V1.

Subsequently, the controller 80 rotates the stepping motor 704 by a step number S₃ in the forward direction at a rotation speed by which the carriage 111 is moved at the second velocity V2 smaller than the first velocity V1, from a point in time at which the carriage 111 has arrived at the right sensor light re-receiving position. Accordingly, the carriage 111 is moved leftward in the medium widthwise direction at the second velocity V2 which is smaller than the first velocity V1, and the carriage 111 arrives at the left printing position. In a case where the carriage 111 is located at the left printing position, the left end of the sensing target plate PT is located to the left of the left sensor 7061, and the right end of the sensing target plate PT is located between the left sensor 7061 and the right sensor 706r (FIG. 9F). Therefore, the left sensor 7061 is in the light-shielded state, and the right sensor 706r is in the light-receiving state.

The movement of the head assembly HDA described above is described concisely, with reference to FIG. 10. In a case where the controller 80 moves the head assembly HDA from the maintenance position to the right printing position, as depicted in the upper part of FIG. 10, the controller 80 moves the head assembly HDA at the first velocity V1 until the head assembly HDA arrives at the right sensor light-shielded position, and then the controller 80 rotates the stepping motor 704 by the step number S₁ to move the head assembly HDA at the second velocity V2 to the right printing position. In a case where the controller 80 moves the head assembly HDA from the maintenance position to the central printing position, as depicted in the middle part of FIG. 10, the controller 80 moves the head assembly HDA at the first velocity V1 until the head assembly HDA arrives at the left sensor light-shielded position, and then the controller 80 rotates the stepping motor 704 by the step number S₂ to move the head assembly HDA at the second velocity V2 to the central printing position. In a case where the controller 80 moves the head assembly HDA from the maintenance position to the left printing position, as depicted in the lower part of FIG. 10, the controller 80 moves the head assembly HDA at the first velocity V1 until the head assembly HDA arrives at the right sensor light re-receiving position, and then the controller 80 rotates the stepping motor 704 by the step number S₃ to move the head assembly HDA at the second velocity V2 to the left printing position.

The right printing position is an example of “first position”, the central printing position is an example of “second position”, and the left printing position is an example of “third position”. Further, the right sensor light-shielded position is an example of “first preliminary position”, the left sensor light-shielded position is an example of “second preliminary position”, and the right sensor light re-receiving position is an example of “third preliminary position”.

### (4) Movement to Maintenance Position

In a case where the controller 80 moves the head assembly HDA of the first head unit 11 to the maintenance position, the controller 80 firstly rotates the stepping motor 704 of the first moving mechanism 71 in the reverse direction to move the carriage 111 at the first velocity V1 rightward in the medium widthwise direction. The controller 80 continues to move the head assembly HDA rightward in the medium widthwise direction at the first velocity V1 until the output signal of the maintenance position sensor 707 is changed to the light-shielding signal. Then, after the output signal of the maintenance position sensor 704 has changed to the light-shielding signal at a certain point in time, the controller 80 rotates the stepping motor 704 by a predetermined step number in the reverse direction from the certain point in time so that the carriage 111 is decelerated to move at a third velocity V3. Accordingly, the carriage 111 is moved rightward in the medium widthwise direction at the third velocity V3 which is smaller than the first velocity V1, and the carriage 111 arrives at the maintenance position. The third velocity V3 may be the same as the second velocity V2, or the third velocity V3 may be different from the second velocity V2.

### (Initial Adjustment of Printer 100)

In the following, the initial adjustment to be performed at the start of the operation of the printer 100 will be described. The initial adjustment is executed after installing the printer 100 and before starting printing of a desired image on the medium PM by using the printer 100.

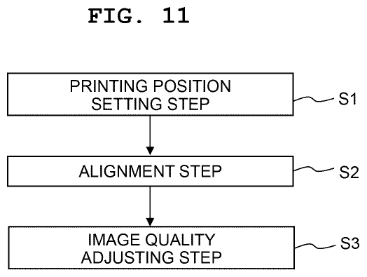

As depicted in a flow chart of FIG. 11, the initial adjustment of the printer 100 includes a printing position setting step S₁, an alignment step S2, and an image quality adjusting step S₃.

In the printing position setting step S₁, the controller 80 sets appropriate positions for the three printing positions (i.e., the right printing position, the central printing position, and the left printing position) with respect to each of the carriage 111 of the first head unit 11 and the carriage 121 of the second head unit 12.

In the printer 100 of the present embodiment, the left sensor 7061 and the right sensor 706r of each of the first moving mechanism 71 and the second moving mechanism 72 are fixed with respect to the casing 90. Further, the sensing target plate PT of the first moving mechanism 71 is fixed to the carriage 111 of the first head unit 11, and the sensing target plate PT of the second moving mechanism 72 is fixed to the carriage 121 of the second head unit 12. Therefore, the right sensor light-shielded position (FIG. 9A), the left sensor light-shielded position (FIG. 9C), and the right sensor light re-receiving position (FIG. 9E) of each of the carriage 111 and the carriage 121 are determined based on the physical configuration (i.e., the positions of the respective sensors and the sensing target plates) of the printer 100.

On the other hand, the right printing position (FIG. 9B) is the position of the carriage 111, 121 at which the carriage 111, 112 is located after the controller 80 has rotated the stepping motor 704 in the forward direction by the step number S₁ from the point in time at which the carriage 111, 121 has arrived at the right sensor light-shielded position. Similarly, the central printing position (FIG. 9D) is the position of the carriage 111, 121 at which the carriage 111, 112 is located after the controller 80 has rotated the stepping motor 704 in the forward direction by the step number S₂ from the point in time at which the carriage 111, 121 has arrived at the left sensor light-shielded position. Similarly, the left printing position (FIG. 9F) is the position of the carriage 111, 121 at which the carriage 111, 112 is located after the controller 80 has rotated the stepping motor 704 in the forward direction by the step number S₃ from the point in time at which the carriage 111, 121 has arrived at the right sensor light re-receiving position. Therefore, the right printing position, the central printing position, and the left printing position can be set to be the appropriate positions, respectively, by causing the controller 80 to appropriately set the values of the step numbers S₁, S₂, S₃ to be used for the control of the stepping motor 704.

A specific procedure for setting the printing position will be described, with a case in which the controller 80 sets the step numbers S₁, S₂, S₃ to be used for the control of the first moving mechanism 71, as an example. Note that the controller 80 also performs the setting of the step numbers S₁, S₂, S₃ to be used for the control of the second moving mechanism 72 in accordance with the same or similar procedure.

At first, the controller 80 rotates the stepping motor 704 of the first moving mechanism 71 in the forward direction to move the carriage 111 leftward. In this process, the controller 80 measures the step number (measured step number MS₁₂, FIG. 10) of the stepping motor 704 required for moving the carriage 111 from the right sensor light-shielded position to the left sensor light-shielded position, based on the number of output pulses outputted from the stepping motor 704. Further, the controller 80 measures the step number (measured step number MS₂₃) of the stepping motor 704 required for moving the carriage 111 from the left sensor light-shielded position to the right sensor light re-receiving position, based on the number of output pulses outputted from the stepping motor 704.

Subsequently, the controller 80 calculates the step number S₁ in accordance with Expression 1 based on the measured step number MS₁₂, the step number S₂, and the step number (designed step number DS₁₂) required for moving the carriage 111 from the right printing position to the central printing position:

$${S}_{1} = {S}_{2} + ( {MS}_{12} - {DS}_{12} ) \qquad ( Expression 1 )$$

In this case, the designed step number DS₁₂ is a value which is stored, for example, in the ROM 82, as a designed value. The right printing position, the central printing position, and the distance between the both positions are determined by the design. The step number, which is required for moving the carriage 111 from the right printing position to the central printing position, is also a fixed value which is determined based on the design. The step number S₂ is inputted, for example, by an operator. The operator may input the designed value of the step number S₂ as it is. Alternatively, the operator may input the designed value after correcting the value so that the central printing position is the designed position.

Subsequently, the controller 80 calculates the step number S₃ in accordance with Expression 2 based on the measured step number MS₂₃, the step number S₂, and the step number (designed step number DS₂₃) required for moving the carriage 111 from the central printing position to the left printing position:

$${S}_{3} = {S}_{2} + ( {DS}_{23} - {MS}_{23} ) \qquad ( Expression 2 )$$

In this case, the designed step number DS₂₃ is a value which is stored, for example, in ROM 82, as a designed value. The central printing position, the left printing position, and the distance between the both positions are determined by the design. The step number, which is required for moving the carriage 111 from the central printing position to the left printing position, is also a fixed value which is determined based on the design.

The controller 80 stores the calculated step numbers S₁, S₃ in the ROM 82 together with the step number S₂ used for the calculation thereof. Further, the controller 80 sets the calculated step numbers S₁, S₃ and the step number S₂ used for the calculation thereof as the step numbers S₁, S₂, S₃ to be used for the control of the first moving mechanism 71.

In the method described above, the step numbers S₁, S₃ are calculated based on the measured step numbers MS₁₂, MS₂₃ as the measured values and the step number S₂ and the designed step numbers DS₁₂, DS₂₃ as the designed values. Therefore, even in a case where at least one of the right sensor light-shielded position, the left sensor light-shielded position and the right sensor light re-receiving position is deviated from the designed position due to the influence of the assembling error among parts constructing the printer 100, etc., the influence of the deviation can be reduced and the space between the respective printing positions can be appropriately set.

In the alignment step S2, the operator performs the alignment for the position of the image to be formed on the medium PM by the head assembly HDA of the first head unit 11 and the position of the image to be formed on the medium PM by the head assembly HDA of the second head unit 12.

The alignment step S2 is performed in a state in which both of the head assembly HDA of the first head unit 11 and the head assembly HDA of the second head unit 12 are located at any one of the right printing position, the central printing position, and the left printing position. By the printing position setting step S₁ described above, the positional relationship among the three printing positions is appropriately set in relation to each of the first head unit 11 and the second head unit 12. Therefore, in a case where the alignment is performed for any one of the three printing positions, the alignment is also completed for the remaining two printing positions.

In the alignment step S2, the operator firstly performs, via the controller 80, formation of a test pattern image by using the head assembly HDA of the first head unit 11 and formation of a test pattern image by using the head assembly HDA of the second head unit 12. Subsequently, the operator inputs, to the controller 80, image pickup data obtained by picking up each of the formed images by scanning. Based on the inputted image pickup data, the controller 80 determines a deviation amount in the medium widthwise direction between a reference nozzle of the first head unit 11 and a reference nozzle of the second head unit 12, i.e., a positional deviation amount in the medium widthwise direction between the image formed by the head assembly HDA of the first head unit 11 and the image formed by the head assembly HDA of the second head unit 12.

After that, the controller 80 performs, for example, the selection of the nozzles NZ to be used for the image formation with respect to each of the head assembly HDA of the first head unit 11 and the head assembly HDA of the second head unit 12, based on the determined positional deviation amount. For example, the nozzles to be used for the image formation are selected so that the nozzles NZ to be used for the image formation among the plurality of nozzles NZ of the head assembly HDA of the first head unit 11 and the nozzles NZ to be used for the image formation among the plurality of nozzles NZ of the head assembly HDA of the second head unit 12 are located in the same area in the medium widthwise direction. With this, the alignment is performed with respect to the position of the image to be formed on the medium PM by the head assembly HDA of the first head unit 11 and the position of the image to be formed on the medium PM by the head assembly HDA of the second head unit 12. Note that the controller 80 may perform the alignment with respect to the position of the image to be formed on the medium PM by the head assembly HDA of the first head unit 11 and the position of the image to be formed on the medium PM by the head assembly HDA of the second head unit 12 by adjusting the step numbers S₁ to S₃ to be used for the movement of the first head unit 11 and/or the step numbers S₁ to S₃ to be used for the movement of the second head unit 12, based on the determined positional deviation amount.

In the image quality adjusting step S₃, the controller 80 performs image quality adjustment with respect to the image to be formed by the head assembly HDA of the first head unit 11 and the image quality adjustment for the image to be formed by the head assembly HDA of the second head unit 12.

A specific procedure of the image quality adjusting step S₃ will be described, with a case where the controller 80 performs the image quality adjustment with respect to the first head unit 11, as an example. The controller 80 also executes the image quality adjustment with respect to the second head unit 12 in accordance with the same or similar procedure as that described below.

The controller 80 moves the head assembly HDA of the first head unit 11 from the maintenance position to the right printing position, and the controller 80 performs formation of a test image on the medium PM by using the head assembly HDA at the right printing position. Subsequently, the controller 80 moves the head assembly HDA of the first head unit 11 to the maintenance position, and the controller 80 moves the head assembly HDA of the first head unit 11 from the maintenance position to the central printing position. Then, the controller 80 performs formation of a test image on the medium PM by using the head assembly HDA at the central printing position. Subsequently, the controller 80 moves the head assembly HDA of the first head unit 11 to the maintenance position, and the controller 80 moves the head assembly HDA of the first head unit 11 from the maintenance position to the left printing position. Then, the controller 80 performs formation of a test image on the medium PM by using the head assembly HDA at the left printing position. After that, the controller 80 performs the image quality adjustment of the image to be formed by the head assembly HDA of the first head unit 11 (specifically, for example, the setting of the voltage to be inputted into the driving element DE) based on the three formed test images. In this way, the test images are formed at the three printing positions, respectively, and the image quality adjustment is performed based on the three test images. Thus, the image quality adjustment can be performed more appropriately by ejecting the inks from all of the nozzles NZ of the head assembly HDA.

The following is the summary of the advantageous effects obtained by the printer 100 of the present embodiment and the method of moving the head unit 10 executed by the controller 80 in the printer 100.

In the printer 100 and the moving method of the present embodiment, the two sensors (right sensor 706r and left sensor 7061) are used to move the head assembly HDA to the three printing positions. Further, the stepping motor 704 is rotated in the forward direction to move the head assembly HDA at the first velocity V1, until the head assembly HDA arrives at the light-shielded position or the light re-receiving portion of one of the two sensors; further, in a case where the head assembly HDA is moved from the light-shielded position or the light re-receiving portion of one of the two sensors, the stepping motor 704 is rotated in the forward direction by the predetermined step number to move the head assembly HDA at the second velocity V2 (the second velocity V2<the first velocity V1).

The printer 100 and the moving method of the present embodiment use the two sensors for moving the head assembly 111 to the three printing positions as described above. Therefore, the head assembly HDA can be moved quickly and precisely to each of the three printing positions. For example, regarding a comparative example including only the right sensor 706r, the following assumption is made. That is, not only the movement of the head assembly HDA to the right printing position but also the movement of the head assembly HDA to the central printing position and the left printing position are realized by moving the head assembly HDA at the second velocity V2 being the low velocity from the right sensor light-shielded position. In this case, since the separation distance between the right sensor light-shielded position and the central printing position or the left printing position is great as depicted in FIG. 10, and thus moving the head assembly HDA quickly to the central printing position or the left printing position is difficult. Note that after the right sensor 706r has turned to the light-shielded state, the head assembly HDA can be moved at the first velocity V1 halfway from the right sensor light-shielded position to the central printing position or the left printing position so as to shorten the time required for moving the head assembly HDA. However, greater the movement velocity by which the head assembly HDA is moved from the right sensor light-shielded position is, lower the accuracy of the alignment with respect to each of the printing positions is. In other words, performing the movement of the head assembly HDA from the right sensor light-shielded position at the first velocity V1 is not desirable, from a viewpoint to secure the accuracy of the alignment to each of the printing positions.

Further, for example, in a comparative example including only the left sensor 7061, the following assumption is made. That is, not only the movement of the head assembly HDA to the central printing position but also the movement of the head assembly HDA to the right printing position and the left printing position is realized by moving the head assembly HDA at the second velocity V2 being the low velocity from the left sensor light-shielded position. However, the separation distance between the left sensor light-shielded position and the right printing position or the left printing position is great. Therefore, moving the head assembly HDA quickly to the right printing position or the left printing position is difficult. Note that after the left sensor 7061 has turned to the light-shielded state, the head assembly HDA can be moved at the first velocity V1 halfway from the left sensor light-shielded position to the right printing position or the left printing position so as to shorten the time required for moving the head assembly HDA. However, greater the movement velocity by which the head assembly HDA is moved from the left sensor light-shielded position is, lower the accuracy of the alignment with respect to each of the printing positions is. Therefore, performing the movement of the head assembly HDA from the left sensor light-shielded position at the first velocity V1 is not desirable. Further, in a case where the head assembly HDA is moved to the right printing position, the direction of rotation (forward direction) of the stepping motor 704, which is adopted in a case where the head assembly HDA is moved at the first velocity V1 until the head assembly HDA arrives at the left sensor light-shielded position, is different from the direction of rotation of the stepping motor 704 which is adopted in a case where the head assembly HDA is moved at the second velocity V2 from the left sensor light-shielded position to the right printing position. Accordingly, the accuracy of the alignment of the head assembly HDA to the right printing position might be lowered by the influence of backlash between the rack gear 701 and the pinion gear 705.

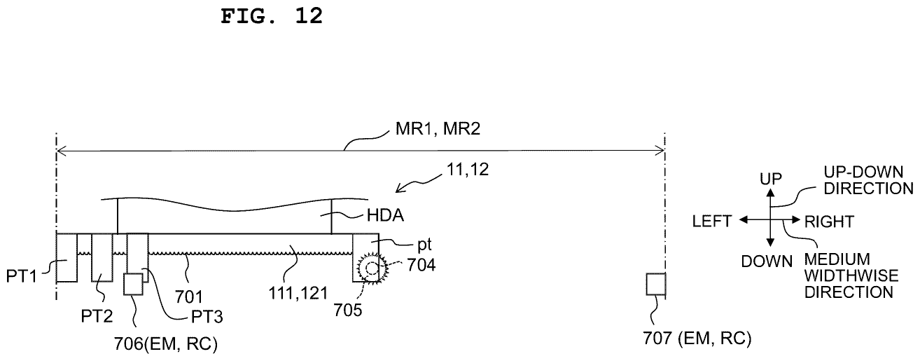

Further, for example, as depicted in a comparative example in FIG. 12, the printer 100 can be configured to include a single optical sensor 706 and a plurality of sensing target plates PT1, PT2, PT3. This comparative example may be configured such that the head assembly HDA is moved at the second velocity V2 to arrive at the right printing position from a position at which the optical sensor 706 turns to the light-shielded state firstly (i.e., a position at which the optical sensor 706 is in the light-shielded state by the sensing target plate PT1). In this configuration, the head assembly HDA can be moved at the second velocity V2 to arrive at the central printing position and the left printing position from positions at which the optical sensor 706 turns to the light-shielded state secondly and thirdly (i.e., positions at which the optical sensor 706 turns to the light-shielded state by the sensing target plate PT2 and the sensing target plate PT3).

However, in the present embodiment, the area in which the right sensor 706r, the left sensor 7061, and the sensing target plate PT are located are such an area that the ink mist generated by the printing tends to adhere. Further, in a case where the ink mist adheres to the sensor 706 or the sensing target plate PT, chattering might occur. The chattering is a phenomenon in which the output of the sensor is unstable. In this phenomenon, for example, the optical sensor 706 inaccurately and repeatedly outputs the output which indicates the light-shielded state and the output which indicates the light-receiving state. This phenomenon is caused, for example, by the adhered ink mist. Therefore, in the configuration depicted in FIG. 12, any erroneous sensing of the position of the head assembly HDA is likely to occur due to the influence of the chattering. For example, in a case where the chattering occurs, the controller 80 might erroneously determine that the carriage 111, 121 is located at the position at which the optical sensor 706 is in the second or third light-shielded state, although the carriage 111, 121 is located at the position at which the optical sensor 706 is in the first light-shielded state. The above-described problem caused by the chattering might occur in the same manner as described above also in a case where a comb teeth-shaped sensing target member having a plurality of sensing target parts is used in place of the plurality of sensing target plates.

In this regard, the printer 100 and the moving method of the present embodiment use the two sensors in the case where the head assembly HDA is moved to the three printing positions as described above. Therefore, the head assembly HDA is not required to be moved over a long distance at the second velocity V2 being the low velocity, and the movement of the head assembly HDA is not influenced by the backlash as well. Further, the two sensors are used, and thus the control based on the output of the sensor is simple. Accordingly, the influence of the chattering is reduced as well. Therefore, according to the printer 100 and the moving method of the present embodiment, the head assembly HDA can be quickly and precisely moved to each of the three printing positions.

In the printer 100 and the moving method of the present embodiment, the sensing target member (more specifically, a sensing target portion, of the sensing target member, actually shields the light) to be sensed by the right sensor 706r is the same as the sensing target member (more specifically, a sensing target portion, of the sensing target member, actually shields the light) to be sensed by the left sensor 7061, and both of them is the single sensing target plate PT. In this way, the number of sensing target members (consequently, the number of sensing target parts) is decreased, thereby decreasing the possibility of occurrence of the ink mist adhesion, and decreasing the possibility of occurrence of the chattering, as well.

In the printer 100 of the present embodiment, the right sensor 706r and the left sensor 7061 are fixed to the casing 90, rather than to the carriage 111, 121. Therefore, no wiring is required for the right sensor 706r and the left sensor 7061 between the casing 90 which is the fixed member and the carriage 111, 121 which is the movable member. This feature is advantageous in that dealing with the movement of the wiring accompanied by the movement of the carriage 111, 121 is not necessary, and that the configuration of the apparatus can be simplified.

In the printer 100 and the moving method of the present embodiment, the dimension in the medium widthwise direction of the sensing target plate PT is greater than the separation distance in the medium widthwise direction between the right sensor 706r and the left sensor 7061. Further, in a case where the head assembly HDA arrives at the right sensor light re-receiving position, the left sensor 7061 is in the light-shielded state. Therefore, in a case where the right sensor 706r is in the light-receiving state, whether the sensing target plate PT (and consequently the head assembly HDA) is located to the left or to the right of the right sensor 706r can be easily determined.

In the printer 100 and the moving method of the present embodiment, the step numbers S₁, S₃ are set based on the step number S₂ and the designed step numbers DS₁₂, DS₂₃ which are designed values and the measured step numbers MS₁₂, MS₂₃ which are the measured values. Therefore, the influence of the assembling error, etc., can be reduced, and the right printing position, the central printing position, and the left printing position can be precisely set.

In the printer 100 and the moving method of the present embodiment, the printing position is set at the position which is shifted by the distance corresponding to the step number S₁, S₂, or S₃ from the position at which the right sensor 706r or the left sensor 7061 reacts, rather than at the position at which the right sensor 706r or the left sensor 7061 reacts. Therefore, the printing position can be finely adjusted without adjusting the physical position of the right sensor 706r or the left sensor 7061 by adjusting the step number S₁, S₂, or S₃. Further, the step numbers S₁, S₃ are greater than the step number S₂. Therefore, for example, in a case where the step number S₂ is adjusted and decreased, any situation, in which the step number S₁ and/or S₃ are/is negative value(s), is prevented. In a case where the step number S₁ and/or S₃ are/is negative value(s), the direction of rotation of the stepping motor is required to be inverted in a case where the head assembly HDA is moved from the right sensor light-shielded position to the right printing position and/or is moved from the right sensor light re-receiving position to the left printing position, due to which the influence of backlash might occur.

The printer 100 and the moving method of the present embodiment use the three printing positions. Accordingly, the inks can be ejected in order to form the image from all of the nozzles NZ possessed by the head assembly HDA, although the dimension in the medium widthwise direction of the medium placement area MA is shorter than the dimension in the medium widthwise direction of the head assembly HDA. Note that the dimension in the medium widthwise direction of the head assembly HDA is the distance in the medium widthwise direction ranging from the nozzle NZ positioned at one end in the medium widthwise direction to the nozzle NZ positioned at the other end in the medium widthwise direction of the head assembly HDA. In this manner, the inks can be ejected from all of the nozzles NZ, which is advantageous in view of reducing the occurrence of any clog-up (ink solidification) of the nozzles which are not used, reducing the change in the propagation of the ink pressure and the change in the ink droplet due to the clog-up, as well as reducing the deterioration in the quality of the image to be formed.

### Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The following modifications can be used in the printer 100 and the moving method of the present embodiment.

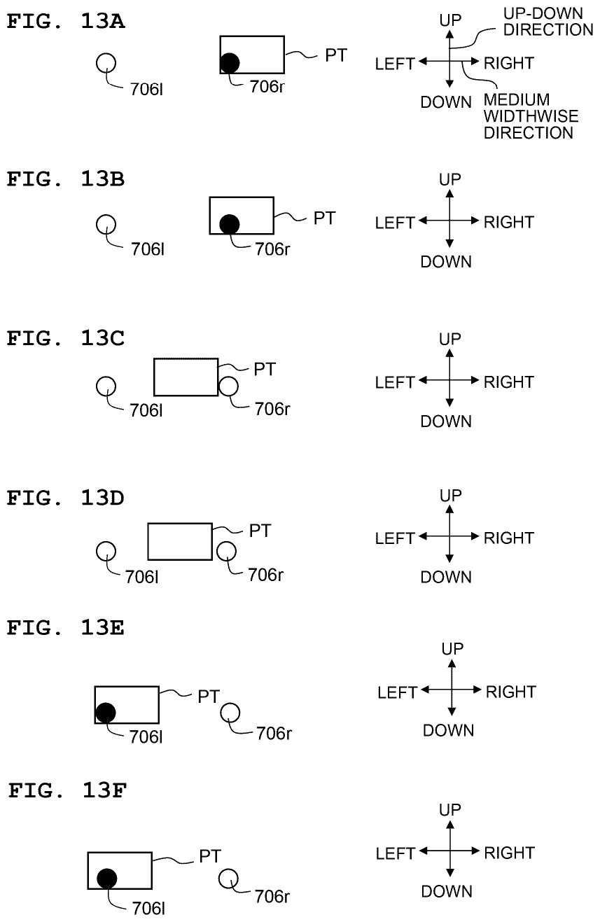

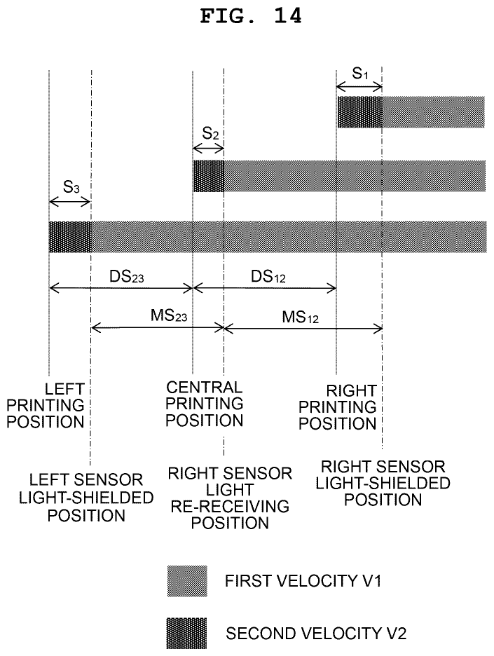

In the printer 100 of the embodiment described above, as depicted in FIG. 9A to FIG. 9F, the length in the medium widthwise direction of the sensing target plate PT is greater than the separation distance in the medium widthwise direction between the left sensor 7061 and the right sensor 706r. However, there is no limitation thereto. For example, as depicted in FIG. 13A to FIG. 13F, the length in the medium widthwise direction of the sensing target plate PT may be shorter than the separation distance in the medium widthwise direction between the left sensor 7061 and the right sensor 706r. The movement of the head assembly in this modification may be, for example, a mode depicted in FIG. 14.

Specifically, in a case where the controller 80 moves the head assembly HDA from the maintenance position to the right printing position, the controller 80 firstly moves the carriage 111, 121 leftward in the medium widthwise direction at the first velocity V1 until the carriage 111, 112 arrives at the right sensor light-shielded position (FIG. 13A) at which the state of the right sensor 706r is changed from the light-receiving state to the light-shielded state. After that, the controller 80 rotates the stepping motor 704 by the step number S₁ in the forward direction. With this, the carriage 111, 112 is moved leftward in the medium widthwise direction at the second velocity V2 which is smaller than the first velocity V1, and the carriage 111, 112 arrives at the right printing position. In a case where the carriage 111, 121 is located at the right printing position, the left end of the sensing target plate PT is located between the left sensor 7061 and the right sensor 706r, and the right end of the sensing target plate PT is located to the right of the right sensor 706r. Therefore, the left sensor 7061 is in the light-receiving state, and the right sensor 706r is in the light-shielded state (FIG. 13B).

In a case where the controller 80 moves the head assembly HDA from the maintenance position to the central printing position, the controller 80 firstly moves the carriage 111, 121 leftward in the medium widthwise direction at the first velocity V1 until the carriage 111, 112 arrives at the right sensor light re-receiving position (FIG. 13C) at which the state of the right sensor 706r is changed from the light-receiving state, via the light-shielded state, to the light-receiving state again. After that, the controller 80 rotates the stepping motor 704 by the step number S₂ in the forward direction. Accordingly, the carriage 111, 112 is moved leftward in the medium widthwise direction at the second velocity V2 which is smaller than the first velocity V1, and the carriage 111, 112 arrives at the central printing position. In a case where the carriage 111, 121 is located at the central printing position, both of the left end and the right end of the sensing target plate PT are located between the left sensor 7061 and the right sensor 706r. Therefore, both of the left sensor 7061 and the right sensor 706r are in the light-receiving state (FIG. 13D).

In a case where the controller 80 moves the head assembly HDA from the maintenance position to the left printing position, the controller 80 firstly causes the carriage 111, 121 to move leftward in the medium widthwise direction at the first velocity V1 until the carriage 111, 112 arrives at the left sensor light-shielded position (FIG. 13E) at which the state of the left sensor 7061 is changed to the light-shielded state. After that, the controller 80 rotates the stepping motor 704 by the step number S₃ in the forward direction. With this, the carriage 111, 112 is moved leftward in the medium widthwise direction at the second velocity V2 which is smaller than the first velocity V1, and the carriage 111, 112 arrives at the left printing position. In a case where the carriage 111, 121 is located at the left printing position, the left end of the sensing target plate PT is located to the left of the left sensor 7061, and the right end of the sensing target plate PT is located between the left sensor 7061 and the right sensor 706r. Therefore, the left sensor 7061 is in the light-shielded state, and the right sensor 706r is in the light-receiving state (FIG. 13F).

In this modification, the right printing position is an example of the “first position”, the central printing position is an example of the “third position”, and the left printing position is an example of the “second position” The step number S₁ of this modification is an example of a “step number S₁” of the claims, the step number S₂ of this modification is an example of a “step number S₃” of the claims, and the step number S₃ of this modification is an example of a “step number S₂” of the claims.

In the printer 100 of the embodiment described above, the left sensor 7061 and the right sensor 706r turns to the light-shielded state (sensing state) by being shielded from the light from the light-emitting part EM by the plate-shaped sensing target plate PT. Further, the maintenance position sensor 707 turns to the light-shielded state (sensing state) by being shielded from the light from the light-emitting part EM by the plate-shaped sensing target plate pt. However, there is no limitation thereto. Any sensing target member including, for example, block-shaped members and pillar-shaped members can be used in place of the plate-shaped sensing target plate PT, pt. Further, each of the left sensor 7061, the right sensor 706r, and the maintenance position sensor 707 may be configured to turn to the sensing state (example of the “ON state”) in a case where the light-receiving part RC receives the light which is emitted from the light-emitting part EM and which is reflected by a mirror disposed in the sensing target member. Other than the above, each of the left sensor 7061, the right sensor 706r, and the maintenance position sensor 707 is not limited to the optical sensor. For example, the sensor may be a contact type sensor which turns to the sensing state (example of the “ON state”) in a case where a contact portion is brought in contact with the sensing target member.

In the printer 100 of the embodiment described above, the right sensor 706r, the left sensor 7061, and the maintenance position sensor 707 are fixed to the frame (not depicted) fixed to the casing 90, and the sensing target plates PT, pt are fixed to the carriages 111, 121. However, there is no limitation thereto. At least one of the right sensor 706r, the left sensor 7061, and the maintenance position sensor 707 may be fixed to the carriage 111, 121, and the corresponding sensing target plate PT, pt may be fixed to the frame (not depicted) fixed to the casing 90. In a case where the sensing target plate PT is caused to move together with the carriage 111, 121, the movement route thereof is an example of “route extending along the head movement direction”. In a case where the sensing target plate PT is fixed to the casing 90, the route of the relative movement of the sensing target plate PT as seen from the right sensor 706r and the left sensor 7061 disposed in the carriage 111, 121 is an example of the “route extending along the head movement direction”.

In the printer 100 of the embodiment described above, the dimension in the medium widthwise direction of the medium placement area is shorter than the dimension in the medium widthwise direction of the head assembly HDA (i.e., the distance in the medium widthwise direction from the nozzle NZ positioned at one end in the medium widthwise direction to the nozzle NZ positioned at the other end in the medium widthwise direction). However, there is no limitation thereto. The dimension in the medium widthwise direction of the medium placement area may be the same as the dimension in the medium widthwise direction of the head assembly HDA, or may be longer than the dimension in the medium widthwise direction of the head assembly HDA.

In the printer 100 of the embodiment described above, the separation distance in the medium widthwise direction between the right sensor 706r and the left sensor 706r and the width in the medium widthwise direction of the sensing target member (for example, the sensing target plate PT) may be set in any manner based on how the positional relationship among the right printing position, the central printing position, and the left printing position is designed. The separation distance in the medium widthwise direction between the right sensor 706r and the left sensor 706r may be greater or smaller than the width in the medium widthwise direction of the sensing target member. Further, the sensing target member to be sensed by the right sensor 706r and the sensing target member to be sensed by the left sensor 7061 may be mutually different sensing target members which are positioned while being separated from each other in the medium widthwise direction.

In the printer 100 of the embodiment described above, the maintenance unit 60 may not have at least one of the maintenance pan 61 and the nozzle cap 63. Further, the printer 100 of the embodiment described above may not have the maintenance unit 60. In the aspect in which the printer 100 does not have the maintenance unit 60, the moving mechanism 70 moves the head unit 10 between the printing position and the waiting position which is to the right of the printing position. The area including the printing position is an example of “image formation area”, and the area including, for example, the maintenance position, the waiting position, and the like. is an example of “escape area”.

In the printer 100 of the embodiment described above, the direction, in which the moving mechanism 70 moves the head unit 10, is the medium widthwise direction which is orthogonal to the conveyance direction. However, there is no limitation thereto. The moving mechanism 70 may be configured to move the head unit 10 (and consequently the head assembly HDA or the head HD) between the image formation area and the escape area, and the movement direction thereof may be any direction.

In the moving mechanism 70 of the printer 100 of the embodiment described above, the driving force of the stepping motor 704 is transmitted to the carriage 111, 121 via the pinion gear 705 and the rack gear 701. However, there is no limitation thereto. The power transmission mechanism, which transmits the driving force of the stepping motor 704 to the carriage 111, 121, may include any mechanism including, for example, a gear, a pulley, a chain, and a belt.

In the printing position setting step S₁ in the initial setting of the embodiment described above, the designed value is used as the step number S₂, and the step numbers S₁, S₃ are calculated based on the measured step numbers MS₁₂, MS₂₃ as the measured values, and the step number S₂ and the designed step numbers DS₁₂, DS₂₃ as the designed value. However, there is no limitation thereto. The designed value may be used as any one of the step numbers S₁ to S₃, and the remaining two of the step numbers S₁ to S₃ may be calculated based on the measured step numbers MS₁₂, MS₂₃ as the measured values, any one of the step numbers S₁ to S₃ being the designed values, and the designed step numbers DS₁₂, DS₂₃. Expressions for the calculation may be appropriately prepared based on the relationships depicted in FIG. 10 and FIG. 14. Other than the above, any setting method may be used for the step numbers S₁ to S₃. For example, the differences between the measured step numbers MS₁₂, MS₂₃ and designed values (ideal values) of these values (i.e., values indicating the magnitude of assembling error) may be calculated; and then values, which are obtained by correcting the designed values (ideal values) of the step numbers S₁ to S₃ based on the differences, may be used as set values of the step numbers S₁ to S₃.

In the embodiment described above, the step number S₂ is greater than the step numbers S₁, S₃. However, there is no limitation thereto. The magnitude correlation among the step numbers S₁, S₂, S₃ may be set in any manner. The step numbers S₁ to S₃ may be equal to each other.

The embodiment and the modifications have been described above as exemplified by the case in which the image is formed on the medium PM by ejecting the inks from the head unit 10. The head unit 10 may be of a liquid ejection system configured to eject any liquid for the purpose of image formation. The medium PM, on which the image is to be formed, may be, for example, a sheet, cloth, or a resin etc.

The embodiment and the modifications described in this specification should be considered as examples in all senses, and should be interpreted not restrictive or limiting in any way. For example, the number, the configuration, etc. of the head assemblies HDA included in the head unit 10 and the number, the configuration, etc. of the heads HD included in the head assembly HDA may be changed. In a case where the head assembly HDA has a single head, the description regarding the position and the dimension of the head assembly HDA in the embodiment and the modifications described above can be interpreted as a description regarding the position and the dimension of the head HD.

The number of colors which are simultaneously printable by the printer 100 is not limited as well. A configuration, in which only the single color printing can be performed, is also adoptable. Further, for example, the number and the position of the individual flow passages, the number of the nozzles NZ, and the number of the nozzle arrays included in the head HD may be appropriately changed as well. The resolution of image formation by the head HD may be any value. For example, the resolution may be 600 dpi or less, or the resolution may be 1200 dpi or more.

The technical features described in the respective embodiment and the modifications can be combined with each other.

The present invention is not limited to the embodiment described above provided that the features of the present invention are maintained. Other aspects, which may be conceived within the scope of the technical concept of the present invention, are also encompassed in the scope of the present invention.

What is claimed is:

1. An image forming system comprising:
a head configured to form an image on a medium by ejecting a liquid;
a head moving mechanism configured to move the head along a head movement direction between an image formation area at one end in the head movement direction and an escape area at other end in the head movement direction, the head moving mechanism including:
a carriage supporting the head;
a stepping motor;
a power transmitter which is connected to the carriage and the stepping motor and which is configured to transmit a power of the stepping motor to the carriage; and
a first sensor and a second sensor each configured to sense that the head is located in the image formation area, and each configured to be in an OFF state in a case where the head is located in the escape area; and
a controller electrically connected to the stepping motor, the first sensor, and the second sensor, the controller being configured to:
in a case where the head is moved from the escape area to a first position in the image formation area, rotate the stepping motor in one direction until the head arrives at a first preliminary position at which the first sensor turns from the OFF state to an ON state, so as to move the head at a first velocity toward the one end, and rotate the stepping motor by a step number S₁ in the one direction from a point in time at which the head has arrived at the first preliminary position, so as to move the head to the first position at a second velocity smaller than the first velocity;
in a case where the head is moved from the escape area to a second position, in the image formation area, different from the first position, rotate the stepping motor in the one direction until the head arrives at a second preliminary position at which the second sensor turns from the OFF state to the ON state, so as to move the head at the first velocity toward the one end, and rotate the stepping motor by a step number S₂ in the one direction from a point in time at which the head has arrived at the second preliminary position, so as to move the head to the second position at the second velocity; and
in a case where the head is moved from the escape area to a third position, in the image formation area, different from the first position and the second position, rotate the stepping motor in the one direction until the head arrives at a third preliminary position at which the first sensor having turned to the ON state by the head having arrived at the first preliminary position turns to the OFF state again, so as to move the head at the first velocity toward the one end, and rotate the stepping motor by a step number S₃ in the one direction from a point in time at which the head has arrived at the third preliminary position so as to move the head to the third position at the second velocity.

2. The image forming system according to claim 1, wherein a distance between two of the first position, the second position, and the third position adjacent to each other in the head movement direction is equal to a length of the head in the head movement direction.

3. The image forming system according to claim 1 further comprising a single sensing target configured to move relative to each of the first sensor and the second sensor on a route extending along the head movement direction, wherein:
the first sensor is configured to be switched between the ON state and the OFF state based on a positional relationship between the first sensor and the sensing target configured to move on the route relative to the first sensor; and
the second sensor is configured to be switched between the ON state and the OFF state based on a positional relationship between the second sensor and the sensing target configured to move on the route relative to the second sensor.

4. The image forming system according to claim 3, wherein the sensing target is positioned on the carriage.

5. The image forming system according to claim 3, wherein the sensing target is a plate extending along the head movement direction.

6. The image forming system according to claim 5, wherein:
a length of the plate in the head movement direction is greater than a distance between the first sensor and the second sensor in the head movement direction;
the first sensor is configured to be in the ON state in a case where the head is located at the second preliminary position; and
the second preliminary position is closer to the one end than the first preliminary position in the head movement direction, and the third preliminary position is closer to the one end than the second preliminary position in the head movement direction.

7. The image forming system according to claim 6, wherein the controller is configured to:
move the head in the head movement direction from the first preliminary position to the second preliminary position so as to measure a step number MS₁₂ being the step number of the stepping motor required for the movement of the head from the first preliminary position to the second preliminary position;
move the head in the head movement direction from the second preliminary position to the third preliminary position so as to measure a step number MS₂₃ being the step number of the stepping motor required for the movement of the head from the second preliminary position to the third preliminary position; and
determine the step number S₁ based on the step number S₂ and the step number MS₁₂, and determine the step number S₃ based on the step number S₂ and the step number MS₂₃.

8. The image forming system according to claim 7, wherein the controller is configured to:
determine the step number S₁ based on the step number S₂, the step number MS₁₂, and a designed step number DS₁₂ being a designed value of the step number of the stepping motor required for moving the head from the first position to the second position, in accordance with an equation of S₁=S₂+(MS₁₂−DS₁₂); and
determine the step number S₃ based on the step number S₂, the step number MS₂₃, and a designed step number DS₂₃ being a designed value of the step number of the stepping motor required for moving the head from the second position to the third position, in accordance with an equation of S₃=S₂+(DS₂₃−MS₂₃).

9. The image forming system according to claim 6, wherein the step number S₁ and/or the step number S₃ are/is greater than the step number S₂.

10. The image forming system according to claim 1, wherein, in the head movement direction, a length of a medium placement area in which the medium is placed during image formation is shorter than a length of the head.

11. The image forming system according to claim 1, wherein the controller is configured to:
move the head from the escape area to one of the first position, the second position, and the third position, and execute image formation on the medium;
after the image formation, move the head to the escape area; and
then move the head from the escape area to other one of the first position, the second position, and the third position, and execute image formation on the medium.

12. The image forming system according to claim 1, wherein:
the head includes a first head and a second head;
the head moving mechanism includes a first head moving mechanism configured to move the first head in the head movement direction and a second head moving mechanism configured to move the second head in the head movement direction; and
the controller is electrically connected to the first sensor, the second sensor, and the stepping motor of each of the first head moving mechanism and the second head moving mechanism.

13. The image forming system according to claim 12, wherein the controller is configured to detect a deviation amount in the head movement direction between a reference nozzle of the first head and a reference nozzle of the second head, and determine a nozzle to be used for image formation performed by the first head and/or a nozzle to be used for image formation performed by the second head based on the deviation amount.

14. The image forming system according to claim 1, wherein the head moving mechanism further includes a third sensor configured to sense that the head is positioned in the escape area.

15. The image forming system according to claim 14 further comprising:
a sensing target which is configured to be sensed by the first sensor and the second sensor and which is disposed on the carriage; and
a sensing target which is configured to be sensed by the third sensor and which is disposed on the carriage,
wherein the sensing target configured to be sensed by the third sensor is disposed closer to the other end in the head movement direction than the sensing target configured to be sensed by the first sensor and the second sensor.

16. A head moving method to be executed by a controller of an image forming system including:
a head configured to form an image on a medium by ejecting a liquid;
a head moving mechanism configured to move the head along a head movement direction between an image formation area at one end in the head movement direction and an escape area at other end in the head movement direction, the head moving mechanism including:
a carriage supporting the head;
a stepping motor;
a power transmitter which is connected to the carriage and the stepping motor and which is configured to transmit a power of the stepping motor to the carriage; and
a first sensor and a second sensor each configured to sense that the head is located in the image formation area, and each configured to be in an OFF state in a case where the head is located in the escape area; and
the controller electrically connected to the stepping motor, the first sensor, and the second sensor,
the head moving method comprising:
in a case where the head is moved from the escape area to a first position in the image formation area, rotate the stepping motor in one direction until the head arrives at a first preliminary position at which the first sensor turns from the OFF state to an ON state, so as to move the head at a first velocity toward the one end, and rotate the stepping motor by a step number S₁ in the one direction from a point in time at which the head has arrived at the first preliminary position, so as to move the head to the first position at a second velocity smaller than the first velocity, by the controller;
in a case where the head is moved from the escape area to a second position, in the image formation area, different from the first position, rotate the stepping motor in the one direction until the head arrives at a second preliminary position at which the second sensor turns from the OFF state to the ON state, so as to move the head at the first velocity toward the one end, and rotate the stepping motor by a step number S₂ in the one direction from a point in time at which the head has arrived at the second preliminary position, so as to move the head to the second position at the second velocity, by the controller; and
in a case where the head is moved from the escape area to a third position, in the image formation area, different from the first position and the second position, rotate the stepping motor in the one direction until the head arrives at a third preliminary position at which the first sensor having turned to the ON state by the head having arrived at the first preliminary position turns to the OFF state again, so as to move the head at the first velocity toward the one end, and rotate the stepping motor by a step number S₃ in the one direction from a point in time at which the head has arrived at the third preliminary position so as to move the head to the third position at the second velocity, by the controller.
